(19) United States
(12) Patent Application Publication
(10) Pub. No.: US 2026/0074201 A1
(43) Pub. Date: Mar. 12, 2026

(54) SYSTEMS AND METHODS FOR ELECTROCHEMICAL ENERGY STORAGE AND RELATED PROCESSES

(71) Applicant: Sunshine Bottling, LLC, Larkspur, CO (US)

(72) Inventor: Frank Edward Overton, Larkspur, CO (US)

(21) Appl. No.: 18/827,278

(22) Filed: Sep. 6, 2024

(51) Int. Cl. H01M 4/36; H01M 12/06; H01M 16/00

(52) U.S. Cl. CPC H01M 4/368; H01M 12/06; H01M 16/003

(57) ABSTRACT

A system may comprise: a liquid-metal electrode; an electrolyte; a counter-electrode, wherein cations exit one of a pair of redox half-reactions at one of the electrode pair and transit through the electrolyte and the liquid-metal electrode to participate in the other redox half-reaction at the other of the electrode pair, and circuitry to convert between electrical energy and chemical bond energy through an electro-chemical redox reaction of the pair of redox half-reactions. A system may comprise: a liquid-metal electrode; an electrolyte; a counter-electrode, wherein anions exit one of a pair of redox half-reactions at one of the electrode pair and transit through the electrolyte and the liquid-metal electrode to participate in the other redox half-reaction at the other of the electrode pair, and circuitry configured to convert between electrical energy and chemical bond energy through an electro-chemical redox reaction of the pair of redox half-reactions.

### FIELD

The present disclosure is related to electrochemical storage and related processes, and particularly to electrochemical cell apparatuses, systems, and methods for converting between chemical bond energy and electrical energy.

### BACKGROUND

Improvements in the ability to compactly and safely store electrical energy by efficiently converting electrical energy to and from chemical bond energy may be foundational to reducing greenhouse gases generated by hydrocarbon fuels and improving numerous types of electrical devices that have become ubiquitous to modern life. The theoretical energy density of metal/air (Oxygen) redox reactions have been identified as possible next-generation electrical energy storage technology. Metal/air redox reactions could make feasible the electrification of difficult industrial sectors such as air transport, trucking, shipping, grid and generator long-duration energy storage which are not economically feasible today.

### SUMMARY

The present disclosure is related to electrochemical storage and related processes, and particularly to electrochemical cell apparatuses, systems, and methods for converting between chemical bond energy and electrical energy. Some system embodiments may include a system comprising: a liquid-metal electrode, wherein a first redox half-reaction is to occur at an interface between a first substance and the liquid-metal electrode; an electrolyte, wherein the liquid-metal electrode is in between the first substance and the electrolyte; a counter-electrode in contact with the electrolyte and separate from the liquid-metal electrode, wherein a second redox half-reaction is to occur at the counter-electrode, the first redox half-reaction and the second redox half-reaction are a corresponding pair of redox half-reactions, the liquid-metal electrode and the counter-electrode are an electrode pair, cations are to exit one of the pair of redox half-reactions at one of the electrode pair and to transit through the electrolyte and the liquid-metal electrode to participate in the other of the pair of redox half-reactions that is to occur at the other of the electrode pair; and circuitry electrically coupled to the liquid-metal electrode and to the counter-electrode, the circuitry being configured to convert between electrical energy and chemical bond energy through an electro-chemical redox reaction of the pair of redox half-reactions.

In some embodiments, the first substance comprises a source of molecules or atoms that are to be electro-chemically reduced to create anions, the counter-electrode comprises a cation source substance that is to be electro-chemically oxidized in the second redox half-reaction to create the cations, wherein the cations are to transit from the counter-electrode through the electrolyte and the liquid-metal electrode to combine with the anions at the interface between the first substance and the liquid-metal electrode in the first redox half-reaction, and the electro-chemical redox reaction of the pair of redox half-reactions between the cations and the anions are to generate electrons to power the circuitry, converting the chemical bond energy of the electro-chemical redox reaction into the electrical energy.

In some embodiments, the first substance comprises a source of molecules or atoms that are to be electro-chemically oxidized to create the cations, the circuitry is configured to input the electrical energy to oxidize the source of molecules or atoms to create the cations at the interface between the first substance and the liquid-metal electrode, the counter-electrode comprises a cation sink for the cations, wherein the cations are to transit from the interface between the first substance and the liquid-metal electrode through the liquid-metal electrode and the electrolyte to the counter-electrode where the second redox half-reaction is to occur, converting the electrical energy input into the chemical bond energy of the electro-chemical redox reaction.

In some embodiments, the liquid-metal electrode comprises a substance with a positive standard electrode potential, or wherein a bias voltage is applied to the liquid-metal electrode to maintain the liquid-metal electrode in a positive electrode potential state. In some embodiments, the liquid-metal electrode comprises a liquid metal or a liquid-metal alloy.

In some embodiments, the cations comprise Aluminum ions, the anions comprise Oxygen ions, the first substance comprises Air as the source of molecules or atoms for the Oxygen ions, the Air including Oxygen, and the counter-electrode comprises Aluminum as the cation source substance for the Aluminum ions, and the Aluminum ions are to transit from the counter-electrode through the electrolyte and the liquid-metal electrode to combine with the Oxygen ions at the interface between the first substance and the liquid-metal electrode in the first redox half-reaction, wherein a by-product of the first redox half-reaction includes Alumina.

In some embodiments, the cations comprise Aluminum ions, the anions comprise Hydrogen ions, the first substance comprises Hydrogen gas as the source of molecules or atoms for the Hydrogen ions, the counter-electrode comprises Aluminum as the cation source substance for the Aluminum ions, and the Aluminum ions are to transit from the counter-electrode through the electrolyte and the liquid-metal electrode to combine with the Hydrogen ions at the interface between the first substance and the liquid-metal electrode in the first redox half-reaction, wherein a by-product of the first redox half-reaction includes Alane.

In some embodiments, the cations comprise Carbon ions, anions comprise Hydrogen ions, the first substance comprises liquid or gaseous molecules hat contain at least Hydrogen and Carbon as the source of molecules or atoms that are to be electro-chemically oxidized to create the cations, the circuitry is configured to provide the electrical energy to split the liquid or gaseous molecules to separate the Hydrogen ions and the Carbon ions at the interface between the first substance and the liquid-metal electrode, and the counter-electrode comprises a cation sink for the Carbon ions, wherein the Carbon ions are to transit from the interface between the first substance and the liquid-metal electrode through the liquid-metal electrode and the electrolyte to participate in the second redox half-reaction at the counter-electrode, converting the electrical energy into the chemical bond energy of the electro-chemical redox reaction, wherein by-products of the electro-chemical redox reaction includes a Carbon by-product formed at the counter-electrode and Hydrogen gas formed at the liquid-metal electrode, the system further comprising: a second liquid-metal electrode, wherein a third redox half-reaction is to occur at a second interface between the second liquid-metal electrode and a second substance that comprises the formed Hydrogen gas; a second electrolyte, wherein the second liquid-metal electrode is in between the second substance and the second electrolyte; a second counter-electrode comprising Aluminum that is to be electro-chemically oxidized in a fourth redox half-reaction to create Aluminum ions, the third redox half-reaction and the fourth redox half-reaction are a corresponding second pair of redox half-reactions, wherein the Aluminum ions are to transit through the second electrolyte and the second liquid-metal electrode between the second interface and the second counter-electrode in order to combine with the Hydrogen gas at the second interface in the third redox half-reaction of the second pair of redox half-reactions; and second circuitry electrically coupled to the second liquid-metal electrode and to the second counter-electrode, the second circuitry configured to convert between second electrical energy and second chemical bond energy of a second electro-chemical redox reaction of the second pair of redox half-reactions, wherein the second electro-chemical redox reaction between the Hydrogen ions and the Aluminum are to generate second electrons to power the second circuitry, converting the second chemical bond energy of the second electro-chemical redox reaction into the second electrical energy.

In some embodiments, the cations comprise Aluminum ions, the anions comprise Oxygen ions, the first substance comprises Air as the source of molecules or atoms for the Oxygen ions, the Air including Oxygen, and the counter-electrode comprises Alane as the cation source substance for the Aluminum ions, the Aluminum ions are to transit from the counter-electrode through the electrolyte and the liquid-metal electrode to combine with the Oxygen ions at the interface between the first substance and the liquid-metal electrode in the first redox half-reaction, wherein a by-product of the first redox half-reaction includes Alumina, and the electrolyte is configured to strip the Aluminum ions off the Alane of the counter-electrode, releasing Hydrogen gas. In some embodiments, the system further comprises: a Hydrogen fuel cell configured for using the released Hydrogen gas as a Hydrogen fuel; a source feed to input into the Hydrogen fuel cell, wherein the Hydrogen fuel cell is configured for operating, based on the released Hydrogen gas and substance input via the source feed, to generate second electrons to power second circuitry.

In some embodiments, the liquid-metal electrode internally contains a mesh configured for creating surface tension, and a by-product of the chemical redox reaction forms at a liquid-metal surface of the liquid-metal electrode in an additive process as the chemical redox reaction occurs, a shape of the liquid-metal surface based on the surface tension of the mesh, a shape of the by-product based on the shape of the liquid-metal surface of the liquid-metal electrode. In some embodiments, the system further comprises: a nano, mezzo or macro scale template at or near the interface between the first substance and the liquid-metal electrode reaction surface, the template configured for modifying the first redox half-reaction occurring at different locations at the interface, which modifies the by-product forming at the liquid-metal surface of the liquid-metal electrode.

In some embodiments, the first substance comprises one or more polar gases as the source of molecules or atoms that are to be electro-chemically reduced to create the anions, and a by-product of the first redox half-reaction sequesters the one or more polar gases. In some embodiments, the system further comprises: a barrier substance for separating the first substance, which comprises one or more non-polar gases, from an external substance, which comprises the one or more polar gases and one or more non-polar gases; a second liquid-metal electrode, wherein a third redox half-reaction is to occur at a second interface between the second liquid-metal electrode and a second substance including a first non-polar gas among the one or more non-polar gases, wherein the first non-polar gas is to be electro-chemically reduced to create second anions; a second electrolyte, wherein the second liquid-metal electrode is in between the second substance and the second electrolyte; a second counter-electrode comprising a second cation source substance that is to be electro-chemically oxidized in a fourth redox half-reaction to create second cations, the third redox half-reaction and the fourth redox half-reaction are a corresponding second pair of redox half-reactions, wherein the second cations are to transit through the second electrolyte and the second liquid-metal electrode between the second interface and the second counter-electrode in order to combine with the second anions at the second interface in the third redox half-reaction of the second pair of redox half-reactions.

Some system embodiments may include a system comprising: a liquid metal-electrode, wherein a first redox half-reaction is to occur at an interface between a first substance and the liquid-metal electrode; an electrolyte, wherein the liquid-metal electrode is in between the first substance and the electrolyte; a counter-electrode in contact with the electrolyte separate from the liquid-metal electrode, wherein a second redox half-reaction is to occur at the counter-electrode, the first redox half-reaction and the second redox half-reaction are a corresponding pair of redox half-reactions, the liquid-metal electrode and the counter-electrode are an electrode pair, anions are to exit one of the pair of redox half-reactions at one of the electrode pair and to transit through the electrolyte and the liquid-metal electrode to participate in the other of the pair of redox half-reactions that is to occur at the other of the electrode pair; and circuitry electrically coupled to the liquid-metal electrode and to the counter-electrode, the circuitry being configured to convert between electrical energy and chemical bond energy through an electro-chemical redox reaction of the pair of redox half-reactions.

In some embodiments, the first substance comprises a source of molecules or atoms that are to be electro-chemically oxidized to create cations, the counter-electrode comprises a anion source substance that is to be electro-chemically reduced in the second redox half-reaction to create the anions, wherein the anions are to transit from the counter-electrode through the electrolyte and the liquid-metal electrode to combine with the cations at the interface between the first substance and the liquid-metal electrode in the first redox half-reaction, and the electro-chemical redox reaction of the pair of redox half-reactions between the cations and the anions are to generate electrons to power the circuitry, converting the chemical bond energy of the electro-chemical redox reaction into the electrical energy.

In some embodiments, the first substance comprises a source of molecules or atoms that are to be electro-chemically reduced to create the anions, the circuitry is configured to input the electrical energy to reduce the source of molecules or atoms to create the anions at the interface between the first substance and the liquid-metal electrode, and the counter-electrode comprises an anion sink for the anions, wherein the anions are to transit from the interface between the first substance and the liquid-metal electrode through the liquid-metal electrode and the electrolyte to the counter-electrode where the second redox half reaction is to occur, converting the electrical energy input into the chemical bond energy of the electro-chemical redox reaction.

In some embodiments, the liquid-metal electrode comprises a substance with a negative standard electrode potential, or wherein a bias voltage is applied to the liquid-metal electrode to maintain the liquid-metal electrode in a negative electrode potential state. In some embodiments, the liquid-metal electrode comprises a liquid metal or a liquid-metal alloy.

In some embodiments, the liquid-metal electrode comprises a mesh configured for creating surface tension, and a by-product of the chemical redox reaction forms at a liquid-metal surface of the liquid-metal electrode in an additive process as the chemical redox reaction occurs, a shape of the liquid-metal surface based on the surface tension of the mesh, a shape of the by-product based on the shape of the liquid-metal surface of the liquid-metal electrode. In some embodiments, the system further comprises: a nano, mezzo or macro scale template at or near the interface between the first substance and the liquid-metal electrode reaction surface, the template configured for modifying the first redox half-reaction occurring at different locations at the interface, which modifies the by-product forming at the liquid-metal surface of the liquid-metal electrode.

Some system embodiments may include a system comprising: a fuel cell configured to operate based on a first fuel, the first fuel comprising a first substance; and a barrier substance located internal in or external to the fuel cell, the barrier substance for separating the first substance, which comprises a non-polar gas, from a second substance, which comprises and the non-polar gas and the one or more polar gases, wherein the barrier permits the first substance to pass through the barrier substance to reach a first operation location where the fuel cell is to use the first substance of the first fuel, wherein the barrier blocks the one or more polar gases mixed with the first substance from reaching the first operation location.

Other systems, methods, apparatuses, and features of the present disclosure will be or become apparent to one having ordinary skill in the art upon examining the following drawings and detailed description. It is intended that all such additional systems, methods, apparatuses, and features be included in this description, be within the scope of the present disclosure and protected by the accompanying claims.

### BRIEF DESCRIPTION OF THE DRAWINGS

The accompanying drawings are included to provide a further understanding of the disclosure and are incorporated in and constitute a part of this specification. The components in the drawings are not necessarily to scale, emphasis instead being placed upon clearly illustrating the principles of the present disclosure. The drawings illustrate embodiments of the disclosure and, together with the description, serve to explain the principles of the disclosure.

FIG. 1 illustrates an example Aluminum-Air Fuel Cell.

FIG. 2 illustrates Example Type I: Liquid Metal (LM) Cation Fuel Cell.

FIG. 3 illustrates Example Type II: Liquid Metal (LM) Cation Electrolyzer.

FIG. 4 illustrates Example Type III: Liquid Metal (LM) Anion Fuel Cell.

FIG. 5 illustrates Example Type IV: Liquid Metal (LM) Anion Electrolyzer.

FIG. 6 illustrates example teachings of reforming fossil fuel to Aluminum Hydride and Carbon products.

FIG. 7 illustrates example teachings of combining an exemplary metal-hydride fuel cell and a hydrogen fuel cell.

FIG. 8 illustrates example teachings of an additive manufacturing process.

FIG. 9 illustrates example teachings of concentrating and fixing polar gases while generating electricity.

### DETAILED DESCRIPTION

This disclosure is not limited to the particular apparatuses, systems, and methods described, as these may vary. The terminology used in the description is for the purpose of describing the particular versions or embodiments only, and is not intended to limit the scope. Various examples will now be described. This description provides specific details for a thorough understanding and enabling description of these examples. One skilled in the relevant art will understand, however, various examples may be practiced without many of these details. Likewise, one skilled in the relevant art will also understand that embodiments can include many other obvious features not described in detail herein. Additionally, some well-known structures or functions may not be shown or described in detail herein, so as to avoid unnecessarily obscuring the relevant description.

The present disclosure relates generally to reduction and oxidation chemical (redox) reactions that generate (or consume) electrons from external electrical circuits. More particularly, the present disclosure may concern at least one of the electrodes in an electrochemical cell apparatus and methods for converting chemical bond energy to electrical energy and vice-versa.

Electrochemical cells have long used redox reactions to convert energy stored in chemical bonds to electrical energy, or to store electrical energy in chemical bonds. Electrochemical cells include but are not limited to: primary batteries, secondary batteries, flow batteries, fuel cells, and electrolytic cells. For example, a primary battery is a battery designed to be used once: e.g., a one-time-use AA battery that is discharged and then discarded. For example, a secondary battery is a battery designed to be rechargeable for reuse, e.g., running it backwards where the ions go in the other direction through the electrolyte, and the charge on the electrodes is reversed so that what was the cathode is now the anode, and what was the anode is now the cathode. For example, a fuel cell may run in a forward direction, like a primary battery, but the fuel cell's fuel may be replenished and the fuel cell's waste product may be removed. For example, an electrolytic cell may be run in a direction where electrical energy is input and fuel is made. For example, a flow battery may store energy in an electrolyte.

An electrochemical cell may comprise a positive electrode and a negative electrode, separated by an ionically conductive but electrically insulating electrolyte. Charged atoms, or molecules, called ions, may be removed from one electrode via a redox chemical half-reaction, and traverse through the electrolyte to the other electrode where the second half of the redox reaction takes place, yielding (or consuming) electrons to (or from) an external circuit. An electrochemical cell's electrode may bring into close proximity the following three elements in order for a redox half-reaction to occur:
1. A source material to provide elements or molecules whose ionic charge is changed in the redox half reaction prior to being transported through the electrolyte (or a sink material to receive the charged ions from the electrolyte and whose charge is modified in the redox half reaction at the ion-receiving electrode),
2. the electrolyte, and
3. an electrode to conduct electrical charge to or away from the redox half-reaction at each cell electrode.

It is also useful to understand that redox reactions may have a flow direction. Primary batteries, secondary batteries including flow batteries and fuel cells may have a discharge direction where the energy stored in chemical bonds dissipates and is converted to electrical energy. For some, but not all, redox reactions it is reasonably feasible to reverse this flow and recharge a secondary battery. In the case of a fuel cell reversing the flow electrons and ions, such reversing also may change its name to an electrolytic cell. Reversing the polarity of electric flow to store energy in chemical bonds changes which electrode is positive and which electrode is negative. In other terminology, this reversing may change which electrode is the anode and which electrode is the cathode. The mixing of the terms positive electrode, negative electrode, anode, and cathode can become confusing therefore, the electrode that is a subject of this disclosure is referred to as “the electrode” and the other electrode is referred to as the “counter electrode” to avoid this confusion of polarity-related terms.

The class of electrodes that is a subject of this disclosure may be used in any type of electrochemical cell including but not limited to: primary, secondary and flow batteries as well as but not limited to fuel cells and electrolytic cells. This wide variety of electrochemical cells may be generically referred to below as a “battery”, “cell”, “metal/air battery”, or “Aluminum/air battery” for readability.

While the class of electrodes that is a focus of this disclosure may be particularly useful for metal/air (Oxygen) redox cells, this class of electrodes is not restricted to this usage as this class of electrodes can also be used for metal/fluorine, metal/chlorine and other cation/anion redox reactions as described by redox reactions in the most general sense. Below some examples use Oxygen with the understanding that any other anion could be substituted for Oxygen in those examples. Similarly, some examples use the word “air” but may be substituted with any fluid that brings anions or precursor molecules to the cell electrode.

The class of electrodes that is a subject of this disclosure is also not specific to use with any specific electrolyte or class of electrolytes such as salt-in-solvent, solvent-in-salt, ionic liquid, deep eutectic solvents, liquid, gel, solid or other classes of electrolytes. Various electrolytes are anticipated. In some embodiments, various electrolytes may even be required to handle different electrode materials and operating environments. In short, any electrolyte created by one skilled in the art can be used with this disclosure.

The class of electrodes that is a subject of this disclosure may also work with a variety of counter electrodes made from materials including but not limited to: Aluminum, Lithium, Magnesium, Sodium, Silicon, Chromium and/or others. The counter electrode may also comprise combinations of elements or alloys of materials. The ions from these compound counter electrodes may traverse the electrolyte as individual elemental ions or as ionic molecules comprising more than one element. Additionally, multiple ions of different types may be simultaneously operating within the electrolyte of an electrochemical cell. The counter electrode in the cell may provide both the source (or sink depending upon operational direction) for ions that traverse the electrolyte and a circuit pathway for conducting the electrons to an external circuit. For example, if the counter electrode is the ion source, ions are being stripped from the counter electrode as the counter electrode is being corroded. If the counter electrode is an ion sink, ions are electroplating the counter electrode surface. The counter electrode may or may not be a conductive metal, to be a source or sink for ions that cross the electrolyte. However, a non-conductive ion source or sink may be doped enough to become conductive (e.g. Silicon in a silicon air battery) or may be in close enough proximity to a conductor so that the electrons can “hop” across the electrically insulating ion source/sink to an electrical conductor. Either way, an electrically non-conductive ion source/sink may form a close composite with an electrically conducting material to act as a redox cell electrode. For the purposes of this disclosure, the counter electrode may include these types of composite electrodes.

### Three-Dimensional Counter-Electrodes

A redox reaction rate may be proportional to the contact surface area between the counter-electrode and the electrolyte. Therefore, in addition to the standard foil and rolled foil battery counter-electrodes, three-dimensional (3D) counter-electrodes that increase the surface area available for a given counter-electrode volume or mass may be highly desirable. Significantly increasing the counter-electrode's surface area generally means increasing the counter-electrode's porosity. Several techniques for creating porous metal counter-electrodes include but are not limited to: casting the counter-electrode with a dissolvable salt, sintering particles of a counter-electrode together, various metal foaming methods and spray deposition techniques. As the counter-electrode's porosity increases, maintaining the counter-electrode's electrical integrity/conductivity may become increasingly challenging. Also as the counter-electrode's porosity increases, the ratio of any oxidation layer to un-oxidized metal may increase, potentially to the point that there may be little or no un-oxidized metal remaining to transport across the electrolyte. Therefore, it may also become desirable to use porous counter-electrodes that have not been degraded by other surface processes such as oxidation. Some of the above processes to create counter-electrode porosity can be done in controlled environments that prevent surface degrading processes like oxidation. Creating large un-oxidized counter-electrode surface areas can change the flammability characteristics of the counter-electrode. For example, Aluminum is generally considered non-flammable, but un-oxidized Aluminum nano-powders are an explosively flammable component of many rocket fuels. Well-designed, highly porous, 3D counter-electrodes may be included as counter-electrodes in the electro-chemical cells covered by this disclosure.

### Further Consideration of Specific Counter-Electrode Materials

### Beryllium (BeO)

The Beryllium Oxygen couple may be the most energy-dense chemical bond that does not utilize Fluorine. (Cells using Fluorine as the anion are included in the cells covered by this disclosure.)

In applications where maximum energy density at any cost is paramount, using Beryllium as the counter-electrode may generate the highest energy density possible in a redox cell, unless the use of Fluorine is acceptable.

### Lithium (Li₂O)

Lithium's energy density is well known because of the pervasive use of Li-ion batteries today. The Lithium Oxygen couple (Li₂O) may have the highest energy density, 5,217 Wh/kg, of any widely available metallic element. The Lithium-air (Li₂O) fuel cells and batteries enabled by this disclosure have the potential to surpass energy density of today's best Lithium-ion batteries by a wide margin. While Lithium is widely available, due to the recent increase in Lithium-ion battery usage, Lithium supply may be relatively scarce and expensive. Another potential concern with Lithium metal may be its flammability, which can be addressed with suitable cell design precautions. Still another potential concern with Lithium is that it reacts with water. Yet another concern with Lithium-air batteries may be the existence of Lithium Peroxide (Li₂O₂), which below 160 degrees Fahrenheit may be thermodynamically preferred over the more energy-dense and desirable form of di-Lithium Oxide (Li₂O). Each of these concerns can be addressed, and Lithium-air cells enabled by this disclosure are commercially significant designs. Lithium-air cells do have notable aspects, one is that the (Li₂O) couple is reversible and allows for the creation of secondary batteries. Lithium's theoretical operating voltage is also relatively high.

Aluminum (Al₂O₃)

The Aluminum-Oxygen couple, 4,310 Wh/kg, may be the next most energy-dense metallic bond in the periodic table. In addition to being energy-dense, Aluminum and Alumina are volumetrically dense, meaning they are compact and easily transportable. Both Aluminum, the fuel, and Alumina, the redox reaction by-product, are non-toxic and environmentally friendly. Aluminum is the third-most prevalent element on earth, and Oxygen is the most prevalent element on earth, so the supply of each is essentially unlimited and cheap. A well-developed Aluminum production industrial base already exists. The input material for Aluminum production is alumina, which means the industrial base to recycle redox reaction by-product, alumina, back into Aluminum, the fuel, also already exists. Notable for an energy-dense fuel, Aluminum is not flammable.

In light of these aspects, Aluminum is the counter electrode material described below with the understanding that any counter electrode and cation may be substituted for Aluminum. Similarly, Oxygen may often be used as the anion in the following descriptions with the understanding that any anion may be substituted for Oxygen.

The electrode that is a subject of this disclosure may be an electrode that combines the metal cations (such as Aluminum) with an anions (such as Oxygen), or an electrode that separates the cations (such as Aluminum) from anions (such as Oxygen). There may be two primary issues addressed by this electrode. First, when a metal cation and oxide anion combine in a redox reaction, the metal oxide that forms on the electrode may be both solid and non-conductive. As this solid and non-conductive metal oxide forms, it may create an electrically insulating barrier that may inhibit and soon prevent electrons from reaching or leaving the redox reaction site. Further, the build-up of this solid metal-oxide may soon block the physical transport of ion source fluid to the reaction site, which may then “coke” or stop the redox reaction. So a first consideration may be preventing reaction product build-up that restricts electron and/or ion source fluid access to the reaction site.

A second consideration may be that the most useful (e.g., energetic) cation-anion pairs may spontaneously chemically combine, regardless of whether or not a conductor is present. Reactions without a conductor are not redox reactions and do not generate or consume electrons. Non-redox reactions may or may not be desirable depending upon the application. In view of this second consideration, for a redox reaction, the electrode may be bringing the cation and anion into close proximity to itself, while preventing the cation and anion from interacting or reacting with each other directly, away from the electrode (e.g., combustion in the case of Oxygen).

The class of electrodes that may address these two considerations, and may be a focus of this disclosure, may be electro-positive (or near-electro-positive) liquid metal electrodes that are both ionically and electrically conductive. An electrically conductive liquid metal electrode may be used in an electrochemical cell. But a significant technique disclosed here is conducting metal cations through the electrolyte and also through the electro-positive, liquid metal electrode, so that the cation-anion reaction takes place on the far surface of the liquid metal electrode that is exposed to the anion source fluid (air). The liquid metal may flow to cover the electrolyte and may form a seal against the cell wall, effectively sealing off the electrolyte from the anionic source fluid (air) by creating a liquid metal barrier between the electrolyte and anionic fluid. This may address the second consideration described above, because the anion (Oxygen) cannot access the cation (Aluminum) when the cation is in the electrolyte or has not yet traversed the liquid metal electrode. The liquid metal electrode may seal off the electrolyte from the air/Oxygen and the cations may come into contact with the anion after the cation has traversed the liquid metal electrode. In some embodiments, the cations may come into contact with the anion only after the cation has traversed the liquid metal electrode. The cation may remain at the liquid metal electrode's surface while and until the cation combines with an anion and forms a redox half reaction.

The first consideration of “coking” may be addressed because the liquid nature of the reaction surface may make an unstable foundation for the formation of metal-oxides. The liquid metal may simply flow away from the metal-oxide reaction product.

Hereafter, a liquid metal electrode of this disclosure may refer to a liquid metal electrode that may provide a sealing barrier between the electrolyte and the anion source, may transport cations between the electrolyte and anion source, and may form an unstable foundation for the formation of coking oxides, fluorides or whatever the anion may be, as provided in this disclosure.

Each of two qualities that describe this class of electrode that are a subject of this disclosure are discussed in further detail below.

### Positive Electrode Potential (or Near-Positive Electrode Potential)

If a liquid metal electrode does not have a positive electrode potential, an oxide layer (or other anion layer) may form on the surface of the electrode and coke it off from further oxidation. The oxide layer formation may prevent bringing the cation (e.g., Aluminum), anion (e.g., Oxygen) and liquid metal electrode (e.g., Mercury) into close proximity for the redox reaction to take place. A near-positive electrode potential liquid metal, such as Gallium (Ga³⁺+3e⁻↔Ga(s) standard electrode potential E₀=−0.55V), could also be used if a 0.55V (or larger) bias is applied to drive the oxidation layer off the Gallium and/or prevent the oxidation layer from forming. So metals with small bias voltages may work via applying bias voltages. In this disclosure, an element or electrode with a positive electrode potential or that is electropositive is indicated by a standard electrode potential having a positive sign. Similarly, in this disclosure, an element or electrode with a negative electrode potential or that is electronegative is indicated by a standard electrode potential having a negative sign.

### The Liquid Nature of the Electrode

At high enough temperatures, all metals melt, become liquid and included as an electrode covered by this disclosure. On Earth, practically it takes substantial energy to melt most metals and more energy to keep them at an elevated temperature. This substantial energy expenditure may reduce the cell's efficiency and may increase the cell's complexity and cost. All other factors being equal, metals with the lowest melting points may yield the cells with relatively higher performance.

TABLE 1
15 Lowest Melting Point Metals and
their Standard Electrode Potentials

| | Melting Point (° C.) | Electrode Potential (V) |
|---|---|---|
| Metal | (from ptable.com) | (from wikipedia.com) |
| Mercury (Hg) | −38.8 | 0.85 |
| Francium** (Fr) | 20.9 | −2.9 |
| Cesium (Cs) | 28.4 | −3.0 |
| Gallium (Ga) | 29.8 | −0.55 |
| Rubidium (Rb) | 39.3 | −2.98 |
| Potassium(K) | 63.4 | −2.93 |
| Sodium (Na) | 97.7 | −2.71 |
| Indium (In) | 156.6 | −0.34 |
| Lithium (Li) | 180.5 | −3.04 |
| Tin (Sn) | 231.9 | −0.13 |
| Polonium** (Po) | 255 | 0.76 |
| Bismuth (Bi) | 271.3 | 0.31 |
| Thallium (Tl) | 304 | −3.6 |
| Cadmium (Cd) | 321.1 | −0.4 |
| Lead (Pb) | 327.5 | −0.126 |

**Indicates Radioactive

Table 1 above indicates Mercury may be a suitable metal for the class of electrodes covered by this disclosure with respect to melting point temperature. However, in view of additional aspects, Mercury usage may have environmental considerations to address for widespread usage. A method to encapsulate Mercury within the redox cell and mitigate or eliminate environmental exposure to Mercury is described below.

Other candidate liquid-metal-electrodes covered in this disclosure include but are not limited to:
1. Gallium (and its alloys, e.g. Gallistan) which may be accompanied by a method or technique to address a-0.55V electrode potential.
2. Indium (and its alloys) which has a relatively higher melting point and which may be accompanied by a method or technique to address a-0.34V electrode potential.
3. Tin (and its alloys) which has a relatively higher melting point and which may be accompanied by a method or technique to address a-0.13V electrode potential.
4. Polonium (and its alloys) which has a relatively higher melting point and may be accompanied by a method or technique to address its radioactivity.
5. Bismuth (and its alloys) which has a relatively higher melting point and which may be accompanied by a method or technique to address relatively low electrical conductivity.
6. Cadmium (and its alloys) which has a relatively higher melting point and which may be accompanied by a method or technique to address a-0.4V electrode potential.
7. Lead (and its alloys) which has a relatively higher melting point and which may be accompanied by a method or technique to address a-0.126V electrode potential.

Other electrode metals are also covered by this disclosure and may be practical on earth in large utility settings where the cost of heating the electrode can be spread over a very large amount of energy converted from chemical bonds to electricity or visa-versa.

### Additives, Alloying and Modifying the Liquid Metal Electrode

Additives and metal alloys may be included within the “liquid metal” electrode. Examples include but are not limited to:
1. Adding Indium and/or Tin to Gallium to lower the melting point of Gallium.
2. Adding Indium, Tin, Lead, Cadmium, Zinc, etc. to Bismuth to lower the melting point of Bismuth.
3. Adding Carbon, Carbon allotropes such as buckyballs or nanotubes, or other fine ceramic powders to Mercury to adjust its surface tension or modify its liquid character to a more gel, paste or putty-like composition.
4. Various types of surface modifications may be applied to the electrode, including stabilizing boundary layers in battery design, Atomic Layer Deposition and/or Molecular Layer Deposition.

Any such additive material that may be composited by one skilled in the art to improve and/or tailor the performance characteristics of the “liquid metal” electrode are within the scope of this disclosure.

### Encapsulation Method to Prevent Environmental Effects of Liquid Metals (e.g., Mercury)

A highly desirable feature of Metal/Air redox cells may be that Oxygen anions can be consumed directly from the atmosphere and therefore do not need to be transported with the cell or counted as part of the cell's weight until the redox reaction takes place. This increase in redox cell energy density may be highly desirable in many applications such as electric aircraft or other vehicles (e.g., automobiles, trucks, ships, underwater vehicles, robots, drones, etc.) or human-transportable energy storage (e.g., battery packs carried by humans), as a fuel source more energy dense than hydrocarbons like conventional fossil fuels. Exposing liquid metals to the atmosphere can be environmentally detrimental as may be in the case of Mercury exposure to the environment. In view of such environmental considerations, some sort of encapsulating barrier may be used to encapsulate a liquid metal electrode. Oxygen (or other anions) may be transported from the environment through the encapsulating barrier to the liquid metal electrode so that the liquid metal electrode is encapsulated by the barrier and not directly exposed to the surrounding environment.

There are at least two types of encapsulating barriers that can be used for this purpose: anion conducting electrolytes and/or per-fluorocarbons that are able to dissolve significant quantities of di-oxygen. For example, liquid anion conducting electrolytes are developed and available for Fluorine anions. For another example, solid-oxide electrolytes that conduct oxygen anions could potentially be used with the liquid metal cells of this disclosure. Using solid-oxide electrolytes may involve relatively high operating temperatures (e.g., above 400 degrees Celsius) in order to have a desirable anion transport rate. Apart from Oxygen anion electrolytes with high transport rates, another option for metal/air cells may be per-fluorocarbons encapsulation barriers.

Per-fluorocarbons are a class of materials made up of Fluorine and Carbon atoms which have a property of being able to dissolve and/or evolve di-oxygen molecules in proportion to the partial pressure of Oxygen in the atmosphere. Per-fluorocarbon properties such as melting point, boiling point, viscosity, surface tension, etc., can be tailored by different combinations of Fluorine and Carbon atoms. Below, perfluorodecalin is used as a per-fluorocarbon exemplar having suitable properties at room temperature, with the understanding that any per-fluorocarbon could be used as an environmental barrier for cells using a liquid metal electrode.

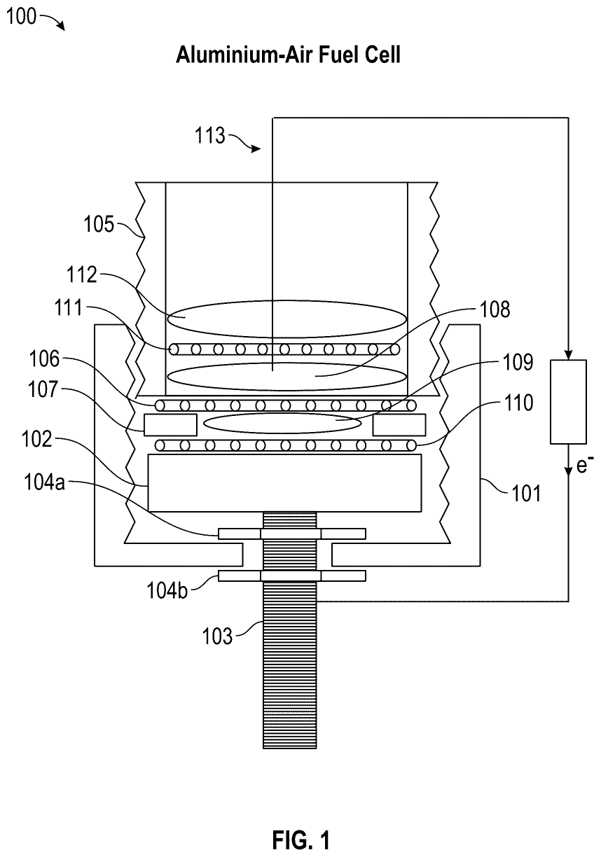

A redox cell's liquid metal electrode can be encapsulated from the atmospheric environment by placing a perfluorocarbon, such as perfluorodecalin, between the atmosphere and the liquid metal inside the redox cell's walls (an example can be seen in FIG. 1). The per-fluorocarbon can be in direct contact with the atmosphere on one side and with the liquid metal electrode on the other side, or the perfluorocarbon can be suspended on a mesh fine enough that the perfluorocarbon's surface tension prevents it from passing through the mesh, between the environmental atmosphere and a controlled atmosphere that contains the liquid metal electrode as one of the controlled atmosphere's boundaries.

Counter-electrode ions, such as Al³⁺, that cross the electrolyte and the liquid metal electrode can remove di-oxygen from whatever is in contact with the opposite side of the liquid metal electrode, be it another electrolyte, a fluorocarbon, a controlled atmosphere or an environmental atmosphere.

### Perfluorocarbon Encapsulation Additional Benefit

The most energetic counter-electrode ions may readily disassociate and combine with hydroxide (OH⁻) derived from water molecules in the atmosphere. A hydroxide anion reaction with a counter-electrode cation may generate less energy in the redox cell's external circuit than a counter-electrode cation reacting with Oxygen anions provided by di-oxygen. Therefore, keeping water and/or steam away from redox reaction site at the liquid metal electrode may improve redox cell performance. As non-polar liquids, per-fluorocarbons may dissolve and transport di-oxygen, which is a non-polar molecule, but may not dissolve or transport polar molecules such as water (H₂O). Per-fluorocarbon's ability to pass di-oxygen, a larger molecule, while simultaneously rejecting water, a smaller molecule, may be a useful feature of per-fluorocarbons. For example, per-fluorocarbons can reject steam while letting oxygen pass through. If a water or steam molecule hits the liquid metal electrode (e.g. Mercury) and combines with a cation (e.g., Aluminum) rather than an O₂ Oxygen molecule, the efficiency of the redox cell may decrease, as AL(OH)₃ instead of Al₂O₃ may be produced. Rejecting a steam molecule but passing through an Oxygen molecule may be non-trivial, as a steam molecule is smaller than an Oxygen molecule, so the operation is not based on physical-size filtration but based on molecular polarity.

As the presence of water (as steam or other state of matter) at the redox reaction site may react with cations, and thus reduce the cell's efficiency, additionally or alternatively, the humidity, wetness, or dryness of the operating conditions may be controlled in other ways, apart from the use of per-fluorocarbons.

### Example 1: Aluminum-Air Fuel Cell

An Aluminum-Air Fuel Cell may consume Oxygen from the air and convert Aluminum to Alumina (Al→Al₂O₃). Distinct from this disclosure, Aluminum Hydroxide (Al→Al(OH)₃) battery and fuel cell proponents calling their products Aluminum Air cells is inaccurate to the term Air. Aluminum Hydroxide cells generally derive their Hydroxide, which contains an Oxygen atom, from water not air. In further distinction, Aluminum Hydroxide cells have less energy density than true Aluminum-Air cells. Even so, Aluminum Hydroxide cells are also covered by this disclosure.

Aluminum-Air fuel cells may be an attractive alternative to Lithium ion batteries for many applications for the following reasons: Aluminum's natural abundance; existing industrial-scale production and Alumina recycling infrastructure; the stability, safety and ease of handling of both Aluminum (fuel) and Alumina (waste product); and the large gravimetric and volumetric energy density of the Aluminum Oxygen redox couple.

FIG. 1 illustrates an example Aluminum-Air cell. The Aluminum-Air cell 100 may comprise a one-inch internally threaded PVC pipe end cap 101 with the threaded opening pointing up on the bottom. Mounted within the end cap may be a one-inch diameter Aluminum rod 102 which may serve as the cell's counter-electrode. The Aluminum rod 102 may be mounted by a threaded hole in the bottom end of the Aluminum rod 102 which may contain a smaller threaded rod 103 screwed into the Aluminum rod 102. The smaller threaded rod 103 may penetrate the bottom of the PVC end cap 101 through a hole. The rod assembly may be sealed and held in place by nuts 104a, 104b on both the inside and outside of the PVC end cap 101. The threaded rod 103 may serve as the anode connection of the fuel cell 100. A one-inch PVC male threaded sprinkler nipple 105 may be threaded into the PVC end cap 101 from the top.

Contained between the lower end of the PVC nipple 105 and the top end of the Aluminum rod 102 are the following elements in order from top to bottom. A finely grated plastic mesh 106 may be glued to the end of the nipple 105. A teflon washer with 0.75-inch internal diameter 107 may be sandwiched between the mesh 106 and the Aluminum rod 102 by tightening the PVC threaded components 101 and 105. Optionally, a fine plastic mesh separator 110 may be included between the Aluminum rod 102 and the teflon washer 107. The pressure created by tightening the PVC threaded components 101 and 105 between the Aluminum rod 102 and the threaded nipple 105 may create a sealed edge surrounding the internal diameter of the teflon washer 107 that may prevent the electrolyte 109, located inside the teflon washer 107 and on top of the Aluminum rod 102 from escaping. A liquid-metal-electrode (e.g., Mercury) 108 may be added on top of the mesh 106 and may make contact with the electrolyte 109 inside the space created by the hole of the teflon washer 107. The mesh 106 may support the liquid-metal-electrode (e.g. Mercury) 108, due to its high surface tension (e.g., of Mercury) that may prevent the liquid-metal-electrode 108 from flowing downward through the mesh 106. The electrolyte 109 may sit between and in contact with both the liquid-metal-electrode (e.g., Mercury) 108 and the Aluminum rod 102. We used both of the following Aluminum-triChloride electrolytes, Uralumina and Emic-Br as the electrolyte 109 in this cell 100. Optionally, a perfluorocarbon 112, such as perfluorodecalin, may be positioned above the liquid-metal-electrode 108. When a perfluorocarbon 112 is used, a fine plastic mesh 111 may optionally also be used to support the perfluorocarbon 112 and create an atmosphere between the liquid-metal-electrode 108 and the perfluorocarbon 112. This atmosphere may be different from the external atmosphere (e.g., having different characteristics than the ion source fluid atmosphere), and the difference may be beneficial for various cell purposes. An external circuit 113 is shown schematically between the metal threaded rod anode 103 and the liquid-metal-electrode 108.

### Cell Operation Description and Results

This Aluminum-Air cell 100 may convert chemical energy into electrical energy. In some embodiments, this cell may only convert chemical energy into electrical energy, e.g., when the Aluminum to Alumina reaction is considered irreversible. The counter-electrode half reaction may be Al→Al³⁺+3e⁻, and the half reaction on the air side of the liquid-metal-electrode may be 3O₂→6O²⁻−12e⁻, 6O₂→+4Al³⁺→2Al₂O₃ which can be rewritten as 3O₂+4Al³⁺→2Al₂O₃+12e⁻. The overall reaction may be 4Al+3O₂→2Al₂O₃.

We used AlCl₃ based electrolytes Uralumina or Emic-Br to strip Aluminum ions, Al³⁺, from the counter-electrode 102. The Aluminum ions from the electrolyte 109 may be amalgamated into the liquid-metal-electrode (e.g., Mercury) 108, just as they would be if the liquid-metal-electrode (e.g., Mercury) 108 were in direct contact with the Aluminum without an electrolyte 109. As the electrolyte 109 loses Aluminum ions to the liquid-metal-electrode 108, the electrolyte 109 may strip additional Aluminum ions from the counter-electrode 102 to keep the electrolyte 109 chemically in balance. The Aluminum ions amalgamated within the liquid-metal-electrode 108 may migrate to the top surface of the liquid-metal-electrode 108. This migration could be driven by buoyancy (e.g., Aluminum being less dense than Mercury), or by the Boltzmann migration of bonding defects (e.g., created by Aluminum's presence in bulk Mercury), migrating to Mercury's surface where defect disruption energy is minimized, or a combination of both. On the liquid-metal-electrode 108 surface opposite the electrolyte 109, the Aluminum ions may encounter Oxygen, from the atmosphere causing a redox reaction that may generate usable electric power to the external circuit 113.

The resulting solid Alumina, Al₂O₃ formed does not coke, and thus does not prevent additional Oxygen from reaching the reaction surface, because the liquid nature of the liquid-metal-electrode 108 may create an unstable base that can flow. This liquid nature may be the same reason that the Mercury-Aluminum amalgamation reaction does not coke, when Mercury is placed in direct contact with Aluminum. Notably, the direct Mercury-Aluminum amalgamation reaction is rather slow, but introducing an electrolyte 109 between the Mercury and Aluminum speeds up the reaction considerably.

The rate at which the Aluminum ions were amalgamated into the Mercury (of the liquid-metal-electrode 108), diffused through the Mercury and reacted with Oxygen were all greater than the rate the electrolyte 109 could strip the ions from the Aluminum and diffuse them through the electrolyte 109. Consequently, the reaction rate per square centimeter of active counter electrode area was the same as the rates reported by some Aluminum ion battery papers, approximately 0.037 mW/cm².

Individual Aluminum and Oxygen atoms in space have the potential to generate 4,311 Wh/kg or 2.73V. Wrestling Aluminum atoms away from Aluminum Chloride electrolyte may lower this potential to ˜3,000 Wh/kg or 0.56V. Using a larger atom or molecule than Chlorine would bind less tightly to Aluminum and may result in higher cell voltages. This assembled Aluminum-Air cell 100 generated a voltage of at least 0.4545V which was 81% of the maximum theoretical voltage, 0.56V. The assembled cell 100 was creating 2,431 Wh/kg of fuel (Aluminum and Oxygen) used. That number would be higher if the weight of the Oxygen, which was stored in the atmosphere, was not counted. These energy densities do not consider the weight of the cell itself; because distinct from a battery, fuel cells may not have a cathode capacity limit. The fuel cell can continuously produce power so long as Aluminum, Oxygen and a place for the Alumina by-product are available.

These energy densities are nearly an order of magnitude greater than the ˜240 Wh/kg offered by today's electric vehicle battery packs, and because it is a fuel cell the amount of energy available may be only limited by the size of the fuel tank and, if the alumina is to be recycled and not discarded into the environment, the alumina by-product tank as well.

The above Example 1: Aluminum-Air Fuel Cell may employ cations as the ions that traverse across both an electrolyte and a liquid-metal-electrode. This disclosure includes embodiments that employ cations as the ions that traverse across both an electrolyte and a liquid-metal-electrode, and also includes embodiments that employ anions as the ions that traverse across both an electrolyte and a liquid-metal-electrode.

To facilitate understanding, here are without limitation some example chemical reactions and/or physical phenomena that may be involved. The systems, methods, and devices of this disclosure may involve some of the example characteristics or behaviors below. There may be Aluminum amalgamating into the Mercury. When Aluminum is placed inside Mercury, bond disruptions may be created, and the energy of those bond disruptions may be minimized when the Aluminum is on the surface because the air has less energy than the Mercury bonds. Aluminum is lighter than Mercury, and there may be a buoyancy that may push it up as well. Bond energy minimization and gravity may both contribute. When ions reach the surface, there may be Boltzmann relaxation of bond disruptions. Inside the electrolyte, there may be an ionic bond; there may be an Aluminum cation and some other anion in the electrolyte but not necessary connected to each other. When the Aluminum cation meets the Mercury, the Mercury and the Aluminum may form a metallic bond, and the Aluminum is pulled out of the electrolyte, which may change the balance of the solution; a cation is lost, so the solution wants a new cation and so strips another Aluminum cation off of the Aluminum counter-electrode into the electrolyte. Cations may flow and reach the Mercury surface in a redox reaction with Oxygen in the air. The cation flow may create a voltage across an external circuit between the electrode and the counter-electrode. The ion may traverse completely across the electrolyte and further traverse completely across the electrode as well.

The liquid-metal (e.g., Mercury or other example metal) counter-electrode may seal off the electrolyte and the cation (e.g., Aluminum) from air. If the air were in contact with Aluminum cations in the electrolyte, the Oxygen in the air may react instantly and in a way where the reaction was not in contact with the electrode, resulting in combustion, but not a redox reaction. The liquid-metal-electrode may prevent an anion source (e.g., Oxygen or other example anion source) from interacting directly with the electrolyte cations, by providing a sealing functionality. Due to its liquid nature, the liquid-metal electrode (e.g., Mercury) may flow around any metal oxide by-product formed to find more air.

The liquid-metal electrode may be electropositive. For example, Mercury is electropositive, so Oxygen does not form oxides with Mercury. If Mercury were electronegative, then an oxide layer may form on the Mercury coking off the reaction surface. For another example, Gallium may form an oxide layer on its surface that may cut it off from air, but a bias voltage may be applied to adjust that Gallium to become electropositive and drive off the Oxygen. Such a bias voltage may subtract from the energy of the cell or battery. Some embodiments may use Galinstan, which is an alloy of Gallium, Indium, and Tin, which can reduce Gallium's melting point from about 30 degrees Celsius so that it is liquid at room temperature. For another example, Bismuth may naturally melt around 271 degrees Celsius, but an alloyed form may reduce the melting point to 70 degrees Celsius, and Bismuth may be generally non-toxic to the environment. Some embodiments may use combinations of metals to change properties, e.g., Indium and Tin added to Gallium to adjust Gallium's melting point.

In some embodiments, the liquid metal itself serves as the electrode. In some embodiments, by-products of the redox reaction may form on the liquid metal surface away from the electrolyte and may build-up and be removed while the redox reaction continues.

As mentioned above, an electrochemical cell may bring into close proximity the following three elements in order for a redox half-reaction to occur:
1. A source material to provide atoms or molecules whose charge is changed to create ions for the electrolyte (or a sink material to receive the charged ions from the electrolyte that participate in a redox half reaction),
2. the electrolyte, and
3. electrodes to conduct electrical charge to or away from the redox half-reaction at each cell electrode.
   In another perspective, redox reactions for an electrochemical cell may have these three elements in close proximity (including at the triple-phase boundary of):
A. a cation source or sink,
B. an anion source or sink, and
C. an electron source electrode and an electron sink electrode.

In an electrochemical cell (e.g., fuel cell or electrolyzer) that uses a liquid metal electrode, there may be multiple kinds of distinct reactions. There may be an insertion reaction, intercalation reaction, or a transit reaction. An insertion reaction takes place within the liquid metal, as an ion traverses an electrolyte to encounter the liquid metal and then either reacts with the liquid metal itself (e.g., Ga→Ga(OH⁻)₃) or reacts with a metal alloyed with the liquid metal (e.g., Sn). An intercalation reaction takes place on the electrolyte-facing surface of the liquid metal, as a cell ion traverses an electrolyte to encounter the liquid metal and then, at that surface of the liquid metal, either reacts with the liquid metal itself or reacts with a metal alloyed with the liquid metal. A transit reaction takes place at the far surface of the liquid metal (not the electrolyte-facing surface), as a cell ion traverses an electrolyte to encounter the liquid metal and then transits all the way through the liquid metal to its far surface to react with substance at that far surface of the liquid metal. In a transit reaction, the ion may not react with the liquid metal itself or with any of the liquid metal's components.

As mentioned above, this disclosure includes embodiments that employ cations or anions as the ions that traverse across both an electrolyte and a liquid-metal-electrode. Such embodiments may include the below Example Type I: Liquid Metal (LM) Cation Fuel Cell and Example II: Liquid Metal (LM) Cation Electrolyzer. This disclosure also includes embodiments that employ anions as the ions that traverse across both an electrolyte and a liquid-metal-electrode. Such embodiments may include the below Example Type III: Liquid Metal (LM) Anion Fuel Cell and Example Type IV: Liquid Metal (LM) Anion Electrolyzer.

### Example Type I: Liquid Metal (LM) Cation Fuel Cell

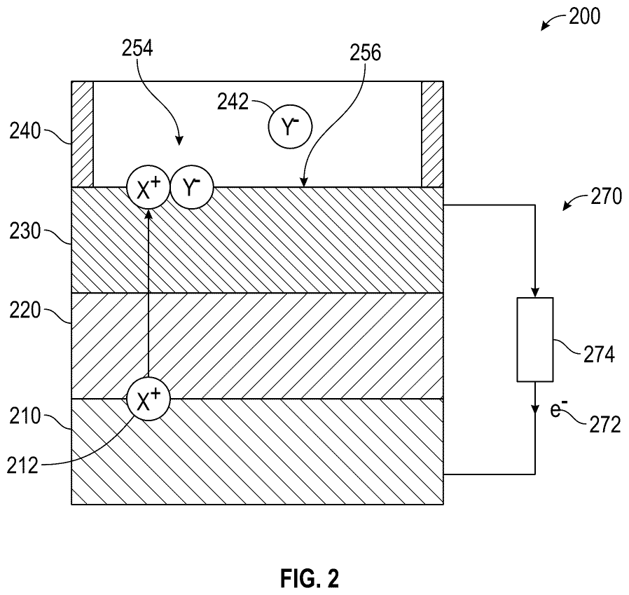

FIG. 2 illustrates Example Type I: Liquid Metal (LM) Cation Fuel Cell. Here, one purpose may be to convert chemical energy into usable electrical energy. As for how an LM Cation Fuel Cell 200 may operate, cations 212 may be stripped from an anode 210, and cations 212 may completely transit both an electrically insulating electrolyte 220 and a conductive liquid-metal cathode 230 to combine with anions 242 on a reaction surface 256 on the side of the cathode 230 facing away from (e.g., opposite) the electrolyte 220. The chemical redox reaction between a cation 212 and an anion 242 may generate electrons 272 that can power an electrical circuit 270 connected to both electrodes of the cathode 230 and the anode 210. The redox reaction between cation 212 and anion 242 may produce reaction by-product 254, such as having a form X_{N}Y_{M} (e.g., Al₂O₃). The electrical circuit 270 may include an electrical load 274, to which the redox reaction may output energy.

The liquid metal cathode 230 may be electropositive to prevent elements or molecules in the anion source (e.g. Oxygen) 240 from reacting with the liquid metal electrode 230 (e.g. Gallium), as such reacting may reduce energy output and create undesirable side reaction by-products (e.g. Ga₂O₃) that could clog up the on-going operation of cell 200. The anion source 240 may be in any state of matter, and a fluid form may include a liquid or gas anion source. The cathode 230 may be a liquid metal and/or a liquid-metal alloy (e.g., Mercury, Bismuth, other example metals and metal alloys of this disclosure). The electrolyte 220 may be a liquid or a solid. The anode 210 may be a source of cations 212 and may be in any state of matter, e.g., solid, liquid, or gas.

In FIG. 2, a cation 212 may be indicated by X⁺. This X⁺ may be any element that can have a positive valence number (e.g., H⁺, Li⁺, Na⁺, Mg²⁺, Al³⁺, Si⁴⁺, etc.), or may be any molecule that carries a positive charge (e.g., NH₄⁺, NO₂⁺, H₃O⁺, etc.). The transit direction of cation 212 is from the anode 210 toward the anion source 240. An anion 242 may be indicated by Y⁻. This Y⁻ may be any element with a negative valence number (e.g., H⁻, F⁻, Cl⁻, O₂⁻, etc.), or any molecule carrying a negative charge (e.g., OH⁻, NO₃⁻, etc.).

Under Example Type I: LM Cation Fuel Cell, the liquid-metal cathode 230 may prevent direct contact between the anion source 240 and the electrolyte 220, and the prevention of such direct contact may prevent the anion source 240 from reacting directly with the electrolyte 220. If the anion source 240 is in direct contact with electrolyte 220, the anion source 240 may react with any constituent part of the electrolyte 220 and degrade the electrolyte's 220 ability to function in a number of different ways. The liquid-metal cathode 230 may act as a barrier that can protect the anion source 240 (e.g., air) from an electrolyte 220 that may pose adverse risks (e.g., potentially toxic, volatile, hazardous, or otherwise deleterious components of electrolyte 220). The liquid nature of the liquid-metal cathode 230 may hinder or prevent build-up of reaction by-product 254, which could clog the flow of anions 242 to the reaction surface 256, which may be called coking. Instead, the liquid-metal cathode 230 can flow around by-product 254 so that the redox reaction can continue, e.g., indefinitely in the presence of sufficient fuel.

### Example Type II: Liquid Metal (LM) Cation Electrolyzer

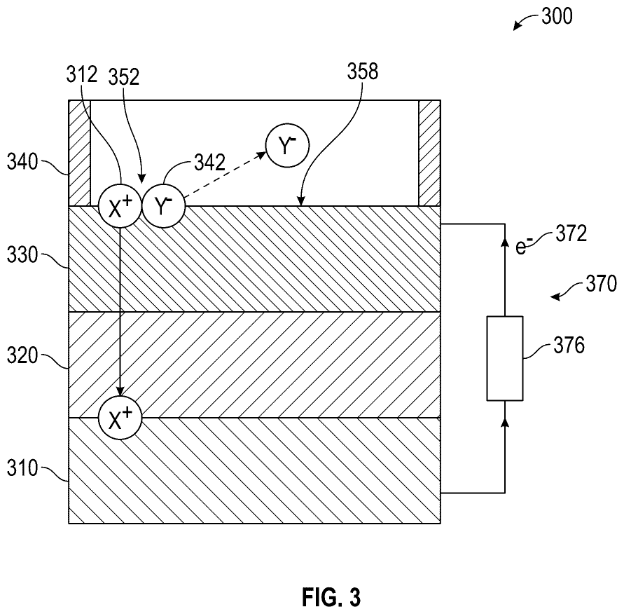

FIG. 3 illustrates Example Type II: Liquid Metal (LM) Cation Electrolyzer. Here, one purpose may be to convert electrical energy into chemical bond energy. Energy in chemical bonds can be easily stored, transported and can be used for other purposes. As for how an LM Cation Electrolyzer 300 may operate, a cation 312 may be stripped from a molecule 352 at a reaction surface 358 on the side of a liquid-metal anode 330 facing away from (e.g., opposite) an electrolyte 320. The molecule's cation 312 may transit across both the liquid-metal anode 330 and the electrolyte 320, and then cation 312 may be plated onto or added to a cathode 310. The original molecule's anion 342 may not cross the liquid-metal anode 330 or electrolyte 320, and may be free to react with other molecules in its environment. Molecule 352, which is to be split, may have a form X_{N}Y_{M} (e.g., H₂O, Li₂O, etc.). The electrical energy for splitting molecule 352 may be provided by electrical energy input or source 376 of an electrical circuit 370, where electrons 372 may flow in the direction from cathode 310 to liquid-metal anode 330.

The liquid-metal anode 330 may be electropositive to prevent anions 342 in the environment from reacting with the liquid metal electrode 330, as such reacting may coke the electrode. The anode 330 may be a liquid metal and/or a liquid-metal alloy (e.g., Mercury, Bismuth, other example metals and metal alloys of this disclosure). The electrolyte 320 may be a liquid or a solid. The cathode 310 (counter-electrode may be in any state of matter, e.g., solid, liquid, or gas.

In FIG. 3, a cation 312 may be indicated by X⁺. This X⁺ may be any element that can have a positive valence number (e.g., H⁺, Lit, Na⁺, Mg²⁺, Al³⁺, Si⁴⁺, etc.), or may be any molecule that carries a positive charge (e.g., NH₄⁺, NO₂⁺, H₃O⁺, etc.). The transit direction of cation 312 is from the cation source 340 toward the counter electrode 310. An anion 342 may be indicated by Y⁻. This Y⁻ may be any element with a negative valence number (e.g., H⁻, F⁻, Cl⁻, O₂⁻, etc.), or any molecule carrying a negative charge (e.g., OH⁻, NO₃⁻, etc.).

Under Example Type II: LM Cation Electrolyzer, the liquid-metal anode 330 may prevent direct contact between the anions 342 and the electrolyte 320, and the prevention of such direct contact may prevent anions 342 from reacting directly with the electrolyte 320. The liquid-metal anode 330 may act as a barrier that can protect the environment (e.g., air) 340 from an electrolyte 320 that may pose adverse risks (e.g., potentially toxic, volatile, hazardous, or otherwise deleterious components of electrolyte 320). The liquid nature of the liquid-metal anode 330 may foster or ensure that X_{N}Y_{M} molecules 352 continue to reach the reaction surface 358, as the liquid-metal anode 330 can flow around the anions 342 that are being released at the reaction surface 358.

### Example Type III: Liquid Metal (LM) Anion Fuel Cell

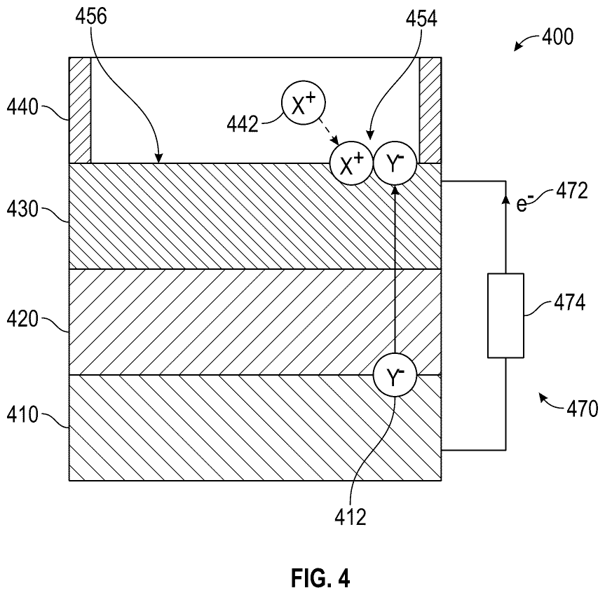

FIG. 4 illustrates Example Type III: Liquid Metal (LM) Anion Fuel Cell. Here, one purpose may be to convert chemical energy into usable electrical energy. As for how an LM Anion Fuel Cell 400 may operate, anions 412 may be stripped from a cathode or counter electrode 410, and anions 412 may completely transit both an electrically insulating electrolyte 420 and a conductive liquid-metal anode 430 to combine with cations 442 on a reaction surface 456 on the side of the anode 430 facing away from (e.g., opposite) the electrolyte 420. The chemical redox reaction between an anion 412 and a cation 442 may generate electrons 472 that can power an electrical circuit 470 connected to both electrodes of the anode 430 and the cathode 410. The redox reaction between anion 412 and cation 442 may produce reaction by-product 454, such as having a form X_{N}Y_{M} (e.g., H₂O, LiF). The electrical circuit 470 may include an electrical load 474, to which the redox reaction may output energy.

The liquid metal anode 430 may be electronegative to prevent the cation source 440 from reacting with the electrode 430, as such reacting may reduce energy output and create undesirable side reaction by-products (e.g., by-products containing a component of the liquid-metal electrode and an anion component of the cation source molecule, such as Ga₂O₃) that could clog up the on-going operation of cell 400. The cation source 440 may be in any state of matter where it can transport cations to the reaction surface. In a fluid form, cation ion source 440 may include a liquid or gas cation source. The anode 430 may be a liquid metal and/or a liquid-metal alloy (e.g., Gallium, Tin, Indium, other example metals and metal alloys of this disclosure). The electrolyte 420 may be in any state of matter. The cathode/counter electrode 410 may be a source of anions 412 and may be in any state of matter, e.g., solid, liquid, or gas.

In FIG. 4, an anion 412 may be indicated by Y⁻. This Y⁻ may be any element that can have a negative valence number (e.g., H⁻, F⁻, Cl⁻, O₂⁻, etc.), or may be any molecule that carries a negative charge (e.g., OH⁻, NO₃⁻, Al₂SO₄²⁻, etc.). The transit direction of anion 412 is from the cathode 410 toward the cation source 440. A cation 442 may be indicated by X⁺. This X⁺ may be any element with a positive valence number (e.g., H⁺, Li⁺, Na⁺, Mg²⁺, Al³⁺, Si⁴⁺, etc.), or any molecule carrying a positive charge (e.g., NH₄⁺, NO₂⁺, H₃O⁺, etc.).

Under Example Type III: LM Anion Fuel Cell, the liquid-metal anode 430 may prevent direct contact between the cation source 440 and the electrolyte 420, and the prevention of such direct contact may prevent the cation source 440 from reacting directly with the electrolyte 420. The liquid-metal anode 430 may act as a barrier that can protect the cation source 440 (e.g., air) from an electrolyte 420 that may pose adverse risks (e.g., potentially toxic, volatile, hazardous, or otherwise deleterious components of electrolyte 420). The liquid nature of the liquid-metal anode 430 may allow the anode to flow by reaction by-product 454, which otherwise could clog the flow of cations 442 to the reaction surface 456, which may be called coking. Instead, the liquid-metal anode 430 can flow around by-product 454 so that the redox reaction can continue, e.g., indefinitely in the presence of sufficient fuel.

### Example Type IV: Liquid Metal (LM) Anion Electrolyzer

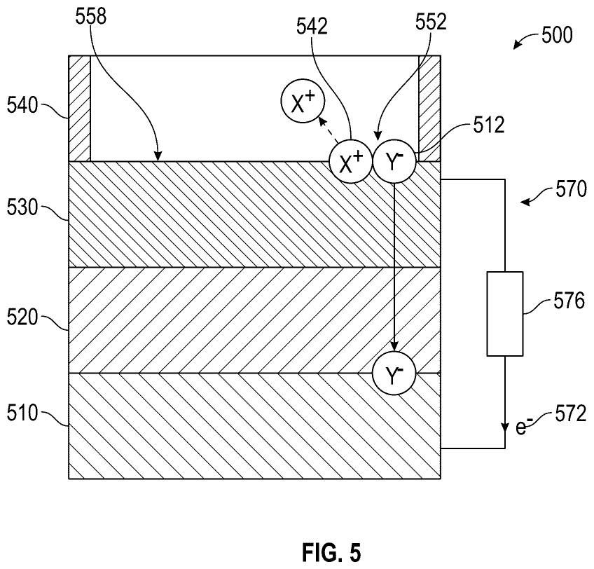

FIG. 5 illustrates Example Type IV: Liquid Metal (LM) Anion Electrolyzer. Here, one purpose may be to convert electrical energy into chemical bond energy. Energy in chemical bonds can be easily stored, transported and can be used for other purposes. As for how an LM Anion Electrolyzer 500 may operate, an anion 512 may be stripped from a molecule 552 at a reaction surface 558 on the side of a liquid-metal cathode 530 facing away from (e.g., opposite) an electrolyte 520. The molecule's anion 512 may transit across both the liquid-metal cathode 530 and the electrolyte 520, and then anion 512 may be plated onto or added to an anode 510. The original molecule's cation 542 may not cross the liquid-metal cathode 530 or electrolyte 520, and may be free to react with other molecules in its environment. Molecule 552, which is to be split, may have a form X_{N}Y_{M} (e.g., H₂O, LiF, etc.). The electrical energy for splitting molecule 552 may be provided by electrical energy input or source 576 of an electrical circuit 570, where electrons 572 may flow in the direction from liquid-metal cathode 530 to anode 510.

The liquid-metal cathode 530 may be electronegative to prevent cations 542 in the environment from reacting with the electrode 530, as such reacting may create undesirable side reaction by-products that could clog up the on-going operation of cell 500. The anion source 540 may be in any state of matter that can transport ions. In a fluid form, the anion source 540 may include a liquid or gas anion source. The cathode 530 may be a liquid metal and/or a liquid-metal alloy (e.g., Gallium, Tin, Indium, other example metals and metal alloys of this disclosure). The electrolyte 520 may be in any state of matter. The anode 510 may be in any state of matter, e.g., solid, liquid, or gas.

In FIG. 5, an anion 512 may be indicated by Y⁻. This Y⁻ may be any element that can have a negative valence number (e.g., H⁻, F⁻, Cl⁻, O₂⁻, etc.), or may be any molecule that carries a negative charge (e.g., OH⁻, NO₃⁻, Al₂SO₄²⁻, etc.). The transit direction of anion 512 is from the anion source 540 toward the anode 510. A cation 542 may be indicated by X⁺. This X⁺ may be any element with a positive valence number (e.g., H⁺, Li⁺, Na⁺, Mg²⁺, Al³⁺, Si⁴⁺, etc.), or any molecule carrying a positive charge (e.g., NH₄⁺, NO₂⁺, H₃O⁺, etc.).

Under Example Type IV: LM Anion Electrolyzer, the liquid-metal cathode 530 may prevent direct contact between the cation source 540 and the electrolyte 520, and the prevention of such direct contact may prevent cation source 540 from reacting directly with the electrolyte 520. The liquid-metal cathode 530 may also act as a barrier that can protect the environment (e.g., air) from an electrolyte 520 that may pose adverse risks (e.g., potentially toxic, volatile, hazardous, or otherwise deleterious components of electrolyte 520). The liquid nature of the liquid-metal cathode 530 may foster or ensure that X_{N}Y_{M} molecules 552 continue to reach the reaction surface 558, as the liquid-metal cathode 530 can flow around the cations 542 that are being released at the reaction surface 558.

### Example of Type I Liquid Metal Cation Fuel Cell: Aluminum Tri-Hydride By-Product Fuel Cell

Some embodiments may use Aluminum and Hydrogen. When the anion source fluid is Hydrogen gas (H₂) and is used with an Aluminum counter electrode, the reaction that may take place on the surface of the liquid electrode may be Al+3/2 H₂↔AlH₃, generated by one or more of the processes above. For example, in view of the Aluminum-Air Fuel Cell in FIG. 1 and/or the Example Type I: LM Cation Fuel Cell in FIG. 2, Hydrogen gas may be used as the anion source (instead of Oxygen gas), and resulting product may include AlH₃ (instead of Alumina Al₂O₃). Aluminum tri-hydride (AlH₃), which is also called Alane, is a highly sought-after Hydrogen storage material containing over 10% Hydrogen by weight. This disclosure may provide an economical route to producing Alane in order to compactly store Hydrogen. Some embodiments of the cationic fuel cell of this disclosure provide a simple, elegant and economical solution to Alane production.

### System and Method to Reform Fossil Fuel to Aluminum Hydride and Carbon Products

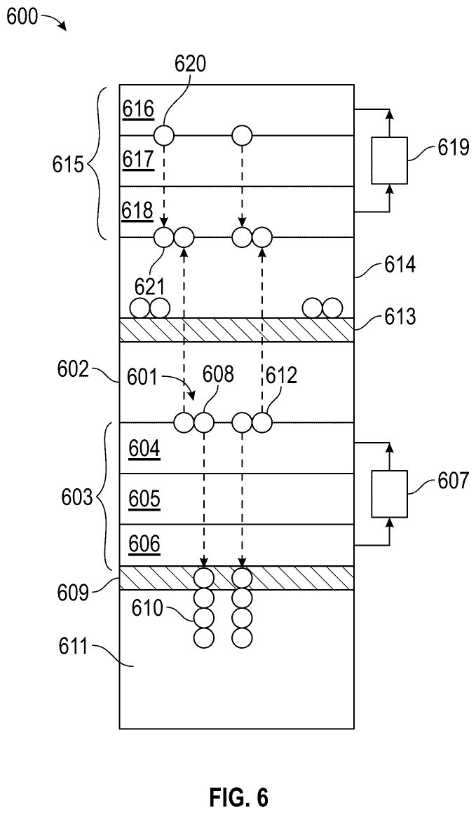

FIG. 6 illustrates example teachings of reforming fossil fuel to Aluminum Hydride and Carbon products. System 600 may be a combination system that may combine an electrolyzer and a fuel cell. In view of the Example Type II: LM Cation Electrolyzer in FIG. 3, the electrolyzer may contain gas or liquid fossil fuels (e.g., Methane CH₄) 601 in a tank 602. Methane molecules 601 may be split by a cationic electrolytic cell 603 with a liquid-metal anode 604, a first electrolyte 605, a cathode 606, and an electricity energy input circuit 607.

Carbon atom (C⁴⁺) 608 (from a methane molecule 601) may traverse the first electrolyte 605 and react with other carbon atoms on the far surface of the cathode 606 (e.g., 2C⁴⁺+8e⁻→2C). The nature of the carbon by-products formed can be influenced by the template 609, which may modify the formation reaction on the surface of the cathode 606. The template 609 may provide additional ways of controlling by-product formation. Here, template 609 may be involved in a manufacturing process for carbon products, such as carbon fiber or carbon nanotubes. Depending upon reaction conditions, various Carbon by-products 610 may be formed in chamber 611. These products may include, e.g., soot, carbon fiber, and carbon nanotubes. Chamber 611 may be evacuated to prevent spurious and/or undesired reactions.

Hydrogen H₂ gas atoms 612 may rise and pass through a hydrogen permeable barrier or membrane 613 before entering a second chamber 614. Above second chamber 614 may be a cationic fuel cell 615. In view of the Example Type I: LM Cation Fuel Cell in FIG. 2, this fuel cell 615 may have an Aluminum anode 616, a second electrolyte 617, a liquid-metal cathode (e.g., Mercury) 618, and an external circuit 619.

Aluminum ions 620 may traverse the second electrolyte 617 and the liquid-metal cathode 618 before reacting with Hydrogen molecules 612 to form AlH₃ reaction product 621, which may then collect on the hydrogen-permeable barrier or membrane 613. The above gas collection technique may be called separation by buoyancy.

### Using Aluminum Tri-Hydride as Counter-Electrode

Some embodiments may use Aluminum Tri-Hydride (Alane) as the counter-electrode. For example, in view of the Aluminum-Air Fuel Cell in FIG. 1 and/or the Example Type I: LM Cation Fuel Cell in FIG. 2, Aluminum Tri-Hydride may be used as the counter-electrode (instead of Aluminum). In some embodiments, this Alane may even be generated by one or more of the processes above for the Aluminum Tri-Hydride Cells. When Alane is used as the counter electrode instead of pure Aluminum, as the electrolyte strips Al³⁺ ions off the AlH₃ counter electrode, Hydrogen gas is released. This Hydrogen gas may be siphoned off and collected. The collected Hydrogen gas may be used for any variety of purposes, and can even be used as fuel for a separate Hydrogen fuel cell. In some embodiments of an Aluminum Tri-Hydride fuel cell of this disclosure, a siphon or other gas collection technique may remove the released Hydrogen above the Aluminum Tri-Hydride counter-electrode (anode) before the released Hydrogen may cross the electrolyte and the LM electrode, where otherwise the released Hydrogen might combine with the anionic source fluid on the other side of the LM electrode.

### System and Method of Combining an Exemplary Metal-Hydride Fuel Cell and a Hydrogen Fuel Cell

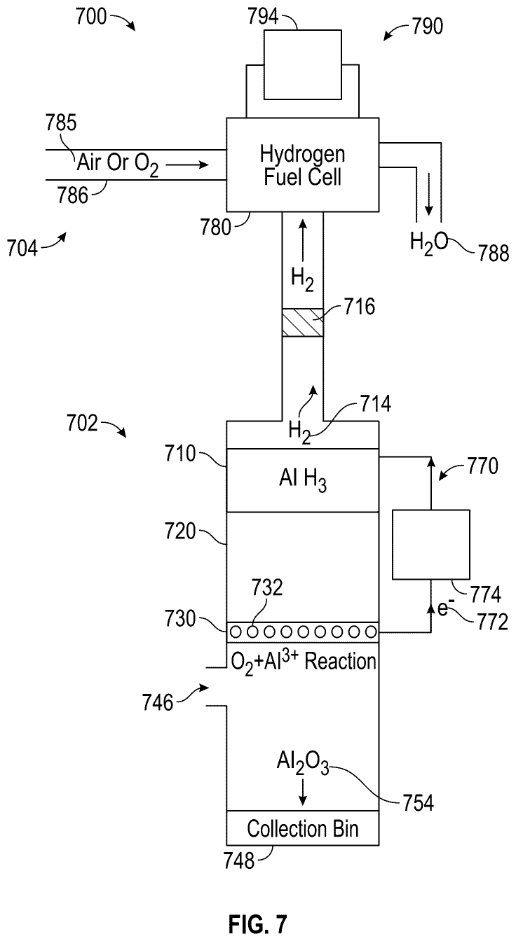

FIG. 7 illustrates example teachings of combining an exemplary metal-hydride fuel cell and a hydrogen fuel cell. System 700 may be a multi-fuel-cell system, such as a dual fuel cell system including first fuel cell 702 and second fuel cell 704. In view of the Example Type I: LM Cation Fuel Cell in FIG. 2, the first fuel cell 702 may use Aluminum Tri-Hydride (Alane AlH₃) as the counter-electrode 710. Al³⁺ ions may be stripped off from the AlH₃ counter-electrode 710, and Hydrogen gas 714 may be released. The AlH₃ counter-electrode 710 may be porous and/or have a high surface area, and AlH₃ may be partially immersed in the electrolyte 720. The Al³⁺ ions may completely transit both an electrolyte 720 and a liquid-metal electrode 730 to combine with Air or Oxygen O₂ (anions) on the side of the electrode 730 facing away from the electrolyte 720. The liquid-metal electrode 730 may be held in place by surface tension with a mesh 732. The chemical redox reaction between Al³⁺ ions and Air or Oxygen (anions) may generate first electrons 772 that can power a first electrical circuit 770 connected to both the counter-electrode 710 and the liquid-metal electrode 730. The redox reaction between Al³⁺ ions and Air or Oxygen (anions) may produce reaction by-product 754 of Alumina Al₂O₃, The electrical circuit 770 may include a first electrical load 774, to which the redox reaction may output energy. The Air or Oxygen may be provided for first fuel cell 702 via, e.g., an Air/Oxygen source feed 746. The reaction by-product 754 of Alumina Al₂O₃ may be collected and/or removed, e.g., via a collection bin 748.

The Hydrogen H₂ gas 714, released from the AlH₃ counter-electrode 710, may be siphoned off and/or collected as the Hydrogen H₂ gas 714 rises up above the counter-electrode 710, as first fuel cell 702 may be oriented such that the down direction in FIG. 7 may be the direction of gravity. The Hydrogen H₂ gas 714 may rise up and/or be collected for input into second fuel cell 704, which may include a hydrogen fuel cell 780. At any location between first fuel cell 702 and second fuel cell 704 (including any location internal or external to second fuel cell 704), system 700 may include a barrier or membrane 716 that can pass the Hydrogen H₂ gas 714 and reject other substances. This barrier or membrane 716 may comprise any substance permeable to the Hydrogen H₂ gas 714, such as perflurodecalin. Hydrogen H₂ gas 714 may be used as Hydrogen fuel for the hydrogen fuel cell 780 of second fuel cell 704. Air or Oxygen O₂ 785 may be provided for second fuel cell 704 via, e.g., another Air/Oxygen source feed 786. Based on the inputs of Hydrogen H₂ gas 714 and Air or Oxygen O₂ 785, the hydrogen fuel cell 780 may operate to generate second electrons 792 that can power a second electrical circuit 790 and also produce output H₂O 788. The second electrical circuit 790 may include a second electrical load 794, to which the hydrogen fuel cell 784 may output energy.

### Additive Manufacturing Process

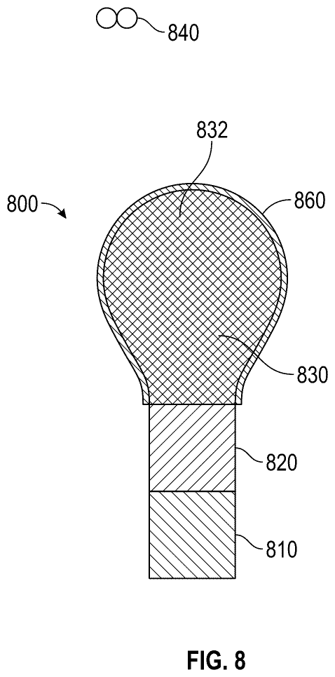

In association with one or more processes above, this disclosure provides a manufacturing process. FIG. 8 illustrates example teachings of a manufacturing process. In accordance with one or more processes above, manufacturing apparatus 800 may comprise a counter-electrode 810 (e.g., an anode comprising Al, Si, B, or other elements or molecules etc.), an electrolyte 820, a liquid metal electrode 830 (e.g., cathode), and exposure to an anion source environment 840 (e.g., anion source such as air). A 2D or 3D mesh 832 may be embedded in the liquid metal electrode 830 (e.g., cathode), and the mesh 832 may create surface tension. This surface tension may partially prevent the liquid metal electrode 830 (e.g., cathode) from flowing. The mesh or shape of the mesh may control large scale flows of the liquid metal through surface tension, while allowing small scale flows for ion transport. Here, large scale may refer to the size of the target additive product, and small scale may refer to the size at the level of ion transport.

As a reaction by-product of the chemical redox reactions discussed above, a by-product (e.g., layer) 860 may form on the surface of the liquid metal 830. The material may form in an additive process as the redox reactions occur. The thickness of the ceramic layer can be controlled by various thickness control techniques. For example, the volume of the liquid metal cathode 830 could be reduced and/or replaced by one of a smaller or different shape over time allowing the by-product layer to grow in thickness. For some material geometries, such as planar materials, the metal cathode 830 could be moved slightly away from the formed layer 860 allowing space for more material to be added to the formed layer thus building the thickness of the formed material in a layer-by-layer manner. The shape of the ceramic layer 860 may be based on the shape of the surface of the liquid metal 830. The shape of the liquid metal surface can be defined by the surface tension of the embedded 2D or 3D mesh 832. The shape of the mesh 832 may be static or vary with time dynamically in size, shape or position. For example, the liquid metal 830 may be partially, or even fully, removed from the mesh 832, and the exposed mesh may be dissolved by an appropriate solvent. Alternatively, the liquid-metal 830 and the mesh 832 may be fully removed and replaced by another liquid-metal and mesh with a slightly altered size or shape, such that the by-product shell grows inwards layer by layer.

Various ceramics may be formed by varying the ion (e.g., cation) transported through the electrolyte and the ion destination (e.g., the anion source), as shown in Table 2 below.

TABLE 2

| | Transiting | Anion | |
|---|---|---|---|
| Examples: | Cation | Source | Resulting Ceramic |
| Silica Glass | Si⁺⁴ | O²⁻ | SiO₂ |
| Boron Nitride | B⁺³ | N³⁻ | BN |
| AlON | Al⁺³ | O²⁻, N³⁻ | (AlN)_{X}(Al₂O₃)_{1-X}, |
| (transparent Aluminum) | | | 1.3 ≤ X < 0.37 |

In different embodiments, the additive manufacturing process could be used in making the following types of products or usages in this non-limiting list: glass light bulbs, plates, bowls, etc.; transparent Aluminum cell phone screens or protectors; technical ceramics such as jet engine turbine blades; useful in integrated circuits manufacturing to deposit ceramic layers at low temperatures. The additive manufacturing process may be a low-temperature process.

When the liquid metal surface is close to planar, the formation or crystallization of reaction products may be tuned, modified, or controlled by generating a standing wave pattern in the liquid metal reaction surface.

Another method to tune, modify, or control the formation or crystallization of reaction products may be to place a nano, mezzo or macro scale template at or near the reaction surface. The template may be configured to modify a redox half-reaction(s) occurring at different locations at the reaction surface, which may modify the by-product forming at the liquid-metal surface of the liquid-metal electrode. The properties of regions within the template may influence the formation or crystallization of the reaction products produced locally Template examples may include but are not limited to: collections of colloidal nanoparticles resting on or near the liquid metal surface and/or metal organic frameworks (MOFs) placed in proximity to the liquid metal's reaction surface. Such template teachings may be implemented in combination with various embodiments of this disclosure, e.g., in the above additive manufacturing process, with template 609 in FIG. 6, etc.

### Conversion and Fixation of Carbon Dioxide

Carbon capture and storage of carbon dioxide (CO₂) is being aggressively pursued in the era of global warming. Guaranteeing perpetual, leakproof storage of the captured CO₂ has been expensive and problematic.

In association with one or more processes above, this disclosure provides a cation fuel cell that may solve this problem by converting carbon dioxide (CO₂) into oxalate. These oxalates may stably fixate the converted CO₂ on the ground or sea floor.

For example, in view of the Aluminum-Air Fuel Cell in FIG. 1 and/or the Example Type I: LM Cation Fuel Cell in FIG. 2, the conversion process may use a cationic fuel cell with the Al³⁺ cation. In some embodiments, the anionic source may be carbon dioxide (CO₂), and the chemical reaction on the liquid metal surface may follow equation 1 below, producing reaction by-product Aluminum Oxalate (Al₂(C₂O₄)₃). Aluminum Oxalate may sequester on the ground three molecules of carbon dioxide for each atom of Aluminum converted.

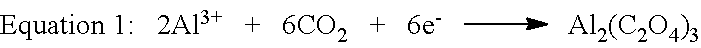

### System and Method of Concentrating and Fixing Polar Gases While Generating Electricity

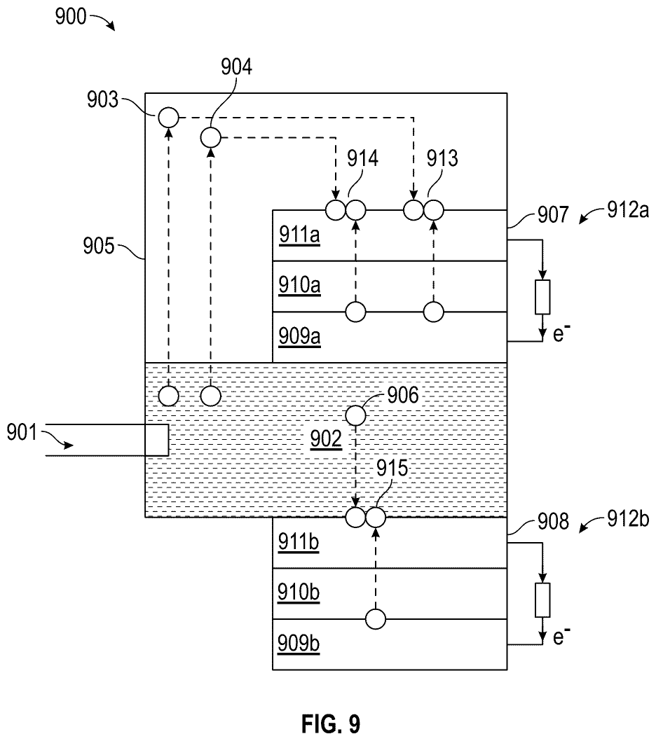

FIG. 9 illustrates example teachings of concentrating and fixing polar gases (such as CO₂, NO₂) while generating electricity. System 900 may be a multi-fuel-cell system, such as a dual fuel cell system including first fuel cell 907 and second fuel cell 908. Mixed gases, such as in Earth's atmosphere 901, may be fed into CarbonFluoroCarbon liquid 902, such as perfluorodecalin.

Within CarbonFluoroCarbon liquid 902, polar gases CO2 903 and NO₂ 904 may be separated, accumulate, and concentrate in a tank 905. Non-polar gases 906, such as Oxygen, may remain dissolved in CarbonFluoroCarbon liquid 902.

In view of the Example Type I: LM Cation Fuel Cell in FIG. 2, two liquid-metal fuel cells 907 and 908 may operate within the system 900. Each may have a respective cation source (e.g., Aluminum) 909a, 909b; a respective electrolyte 910a, 910b; a respective liquid-metal cathode (e.g., Mercury) 911a, 911b; and a respective external circuit 912a, 912b.

In first fuel cell 907, Aluminum 909a may transit the electrolyte 910a and the liquid metal 911a, and react with polar gas molecule CO₂ 903 and NO₂ 904, forming reaction products solid Al₂(C₂O₄)₃ 913 and Al(NO₂)₃ 914, respectively. Each reaction may generate electricity in the first fuel cell 907 for external circuit 912a.

Non-polar gases (e.g., Oxygen) 906 may diffuse through the CarbonFluoroCarbon liquid 902 and react on the surface of liquid-metal 911b of the second fuel cell 908, with Aluminum 909b that has transited the electrolyte 910b and the liquid metal 911b. The reaction may form Al₂O₃ as the reaction product 915 and may generate electricity in the external circuit 912b of the second fuel cell 908.

### System and Method to Reform Fossil Fuel to Carbon Products and Hydrogen Gas for a Hydrogen Fuel Cell

As demonstrated above, the various teachings and embodiments of this disclosure may be mixed and matched with each other in any number of combinations. As another example, aspects of FIG. 6 and FIG. 7 may be combined in a system and method to reform fossil fuels to Carbon products and Hydrogen gas for a Hydrogen fuel cell. Specifically, elements 602 and below from FIG. 6 may serve as an electrolyzer that provides Hydrogen H₂ gas, and elements 714 and above from FIG. 7 may serve as a Hydrogen fuel cell that utilizes the Hydrogen H₂ gas as fuel.

In general, a significant issue with hydrogen fuel cells has been the presence of minuscule amounts of carbon-monoxide present in the hydrogen fuel that is an inevitable by-product of reforming carbon-based fuels (such as Methane, other hydrocarbons, fossil fuels, natural gas, gasoline, ethanol, etc.) into that hydrogen fuel for usage in hydrogen fuel cells. Carbon-monoxide degrades the performance of the platinum catalysts at the heart of hydrogen fuel cells by binding tightly to platinum and preventing the platinum from grabbing the hydrogen fuel.

As exemplified above, a Carbon-Fluoro-Carbon substance, such as perfluorodecalin, can be used as a barrier or separating layer (like barrier or membrane 716 shown in FIG. 7) for liquid-metal-based apparatuses, systems, and methods. Additionally, a Carbon-Fluoro-Carbon substance, such as perfluorodecalin, can be similarly used as a barrier or separating layer for non-liquid-metal-based apparatuses, systems, and methods, such as traditional hydrogen fuel cells where removing minuscule amounts of carbon-monoxide has been a significant technical challenge. Carbon-Fluoro-Carbons can dissolve large amounts of non-polar gas such as Hydrogen but rapidly dispel polar gases such as Carbon-Monoxide. This separating property can be used as a barrier layer to protect sensitive fuel cell components from unwanted contamination.

In some embodiments, the electrochemical cell apparatus may function as a primary battery. In some embodiments, the electrochemical cell apparatus may function as a secondary battery. In some embodiments, the electrochemical cell apparatus may function as a flow battery. In some embodiments, the electrochemical cell apparatus may function as a fuel cell. In some embodiments, the electrochemical cell apparatus may function as an electrolytic cell.

In some embodiments, the electrochemical cell apparatus may comprise a counter-electrode comprising a substance that is Carbon, Beryllium, Aluminum, Lithium, Magnesium, Sodium, Silicon, or Chromium. In some embodiments, the electrochemical cell apparatus may comprise a counter-electrode where the counter-electrode ion is any Periodic Table Group 1 Alkali Metal (Li, Na, K, Rb, Cs, Fr). In some embodiments, the electrochemical cell apparatus may comprise a counter-electrode where the counter-electrode ion is any Periodic Table Group 2 Akaline Earth Metal (Be, Mg, Ca, Sr, Ba, Ra). In some embodiments, the electrochemical cell apparatus may comprise a counter-electrode where the counter-electrode ion is any Periodic Table Group 3-12 Transition Metal (Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs). In some embodiments, the electrochemical cell apparatus may comprise a counter-electrode where the counter-electrode ion is any Periodic Table Inner-Transition Element Lanthanide (La, Ce, Pr, Nd, Pm, Sm, Eu, Gd, Tb, Dy, Ho, Er, Tm, Yb, Lu). In some embodiments, the electrochemical cell apparatus may comprise a counter-electrode where the counter-electrode ion is any Periodic Table Inner-Transition Element Actinide (Ac, Th, Pa, U, Np, Pu, Am, Cm, Bk, Cf, Es, Fm, Md, No, Lr). In some embodiments, the electrochemical cell apparatus may comprise a counter-electrode where the counter-electrode ion is any Periodic Table Group 13-17 Post Transition Metal (Al, Ga, In, Tl, Sn, Pb, Bi, Po) or Metalloid (B, Si, Ge, As, Sb, Te, At). In some embodiments, the electrochemical cell apparatus may comprise a counter-electrode where the counter-electrode ion is any combination or alloy of the counter-electrode ions specified above.

In some embodiments, the electrochemical cell apparatus may comprise a counter-electrode where the counter-electrode ion is any cationic molecule which can be amalgamated or absorbed by a liquid-metal electrode.

In some embodiments, the electrochemical cell apparatus may comprise a counter-electrode having a high surface area electrode including porous and three dimensional structures.

In some embodiments, the electrochemical cell apparatus may comprise an electrolyte and a liquid-metal electrode, where an anion traversing the electrolyte and the liquid metal electrode is a Periodic Table Group 15-17 Reactive Non-metal (N, O, F, P, S, Cl, Se, Br, I). In some embodiments, the electrochemical cell apparatus may comprise an anionic fuel cell where Oxygen is the anion. In some embodiments, the electrochemical cell apparatus may comprise an anionic electrolytic cell where Oxygen is the anion.

In some embodiments, the electrochemical cell apparatus may comprise an electrolyte and a liquid-metal electrode, where an anion traversing the electrolyte and the liquid metal electrode is any element with a negative valence number. In some embodiments, the electrochemical cell apparatus may comprise an electrolyte and a liquid-metal electrode, where an anion traversing the electrolyte and the liquid-metal electrode is any anionic molecule.

In some embodiments, the electrochemical cell apparatus may comprise any electrolyte or any class of electrolytes, such as without limitation to salt-in-solvent, solvent-in-salt, ionic liquid, deep eutectic solvents, liquid, gel, solid or other classes of electrolytes.

In some embodiments, the electrochemical cell apparatus may comprise any metal as the liquid-metal electrode where the liquid-metal electrode is to be operated at any temperature sufficient to keep the liquid-metal electrode in a liquid state of matter. In some embodiments, the electrochemical cell apparatus may comprise any metal as the liquid-metal electrode where the liquid-metal electrode is to be operated with any bias voltage sufficient to prevent the anion the electrochemical cell apparatus uses from reacting with the liquid-metal electrode.

In some embodiments, the electrochemical cell apparatus may comprise a liquid-metal electrode that is alloyed or composited with additives or other substances to modify its properties including but not limited to melting point, boiling point, surface tension, viscosity, etc. In some embodiments, the electrochemical cell apparatus may comprise a liquid-metal electrode where the liquid-metal-electrode's surface properties are modified by methods including but not limited to atomic layer deposition or molecular layer deposition.

In some embodiments, the electrochemical cell apparatus may comprise a liquid-metal-electrode that is protected from undesirable contaminants in an anion source including but not limited to water/steam. In some embodiments, the electrochemical cell apparatus may comprise a liquid-metal electrode and a protective separating barrier, where an anion source and its surrounding environment are separated from the liquid-metal electrode when this protective separating barrier between the liquid-metal electrode and the anion source environment is an anionic electrolyte. In some embodiments, the electrochemical cell apparatus may comprise a liquid-metal electrode and a protective separating barrier, where an anion source and its surrounding environment are separated from the liquid-metal electrode when this protective separating barrier between the liquid-metal electrode and the anion source environment is provided by a perfluorocarbon that dissolves and transfers anionic ion precursor such as but limited to di-Oxygen, di-Florine, di-Chlorine, etc.

In some embodiments, the electrochemical cell apparatus may comprise a protective barrier that is in contact with both an anion source and a liquid-metal electrode. In some embodiments, the electrochemical cell apparatus may comprise a protective barrier that is in contact with an anion source and not a liquid-metal-electrode, such that there is an intervening anion source that has contamination properties different than the electrochemical cell apparatus' external anion source.

In some embodiments, the electrochemical cell apparatus may comprise an ionic electrolyte or a contamination barrier that comprises perfluorocarbon, where the electrolytic cell apparatus may comprise a liquid-metal electrode or may lack a liquid-metal-electrode.

It will be apparent to those skilled in the art that various modifications and variations can be made to the disclosed embodiments of the present disclosure without departing from the scope or spirit of the disclosure. In view of the foregoing, it is intended that the present disclosure cover modifications and variations of the disclosed embodiments.

What is claimed is:

1. A system comprising:
a liquid-metal electrode, wherein a first redox half-reaction is to occur at an interface between a first substance and the liquid-metal electrode;
an electrolyte, wherein the liquid-metal electrode is in between the first substance and the electrolyte;
a counter-electrode in contact with the electrolyte and separate from the liquid-metal electrode, wherein a second redox half-reaction is to occur at the counter-electrode, the first redox half-reaction and the second redox half-reaction are a corresponding pair of redox half-reactions, the liquid-metal electrode and the counter-electrode are an electrode pair, cations are to exit one of the pair of redox half-reactions at one of the electrode pair and to transit through the electrolyte and the liquid-metal electrode to participate in the other of the pair of redox half-reactions that is to occur at the other of the electrode pair; and
circuitry electrically coupled to the liquid-metal electrode and to the counter-electrode, the circuitry being configured to convert between electrical energy and chemical bond energy through an electro-chemical redox reaction of the pair of redox half-reactions.

2. The system of claim 1, wherein:
the first substance comprises a source of molecules or atoms that are to be electro-chemically reduced to create anions,
the counter-electrode comprises a cation source substance that is to be electro-chemically oxidized in the second redox half-reaction to create the cations, wherein the cations are to transit from the counter-electrode through the electrolyte and the liquid-metal electrode to combine with the anions at the interface between the first substance and the liquid-metal electrode in the first redox half-reaction, and
the electro-chemical redox reaction of the pair of redox half-reactions between the cations and the anions are to generate electrons to power the circuitry, converting the chemical bond energy of the electro-chemical redox reaction into the electrical energy.

3. The system of claim 1, wherein:
the first substance comprises a source of molecules or atoms that are to be electro-chemically oxidized to create the cations,
the circuitry is configured to input the electrical energy to oxidize the source of molecules or atoms to create the cations at the interface between the first substance and the liquid-metal electrode,
the counter-electrode comprises a cation sink for the cations, wherein the cations are to transit from the interface between the first substance and the liquid-metal electrode through the liquid-metal electrode and the electrolyte to the counter-electrode where the second redox half-reaction is to occur, converting the electrical energy input into the chemical bond energy of the electro-chemical redox reaction.

4. The system of claim 1, wherein the liquid-metal electrode comprises a substance with a positive standard electrode potential, or wherein a bias voltage is applied to the liquid-metal electrode to maintain the liquid-metal electrode in a positive electrode potential state.

5. The system of claim 1, wherein the liquid-metal electrode comprises a liquid metal or a liquid-metal alloy.

6. The system of claim 2, wherein:
the cations comprise Aluminum ions,
the anions comprise Oxygen ions,
the first substance comprises Air as the source of molecules or atoms for the Oxygen ions, the Air including Oxygen,
the counter-electrode comprises Aluminum as the cation source substance for the Aluminum ions, and
the Aluminum ions are to transit from the counter-electrode through the electrolyte and the liquid-metal electrode to combine with the Oxygen ions at the interface between the first substance and the liquid-metal electrode in the first redox half-reaction, wherein a by-product of the first redox half-reaction includes Alumina.

7. The system of claim 2, wherein:
the cations comprise Aluminum ions,
the anions comprise Hydrogen ions,
the first substance comprises Hydrogen gas as the source of molecules or atoms for the Hydrogen ions,
the counter-electrode comprises Aluminum as the cation source substance for the Aluminum ions, and
the Aluminum ions are to transit from the counter-electrode through the electrolyte and the liquid-metal electrode to combine with the Hydrogen ions at the interface between the first substance and the liquid-metal electrode in the first redox half-reaction, wherein a by-product of the first redox half-reaction includes Alane.

8. The system of claim 3, wherein:
the cations comprise Carbon ions,
anions comprise Hydrogen ions,
the first substance comprises liquid or gaseous molecules that contain at least Hydrogen and Carbon as the source of molecules or atoms that are to be electro-chemically oxidized to create the cations,
the circuitry is configured to provide the electrical energy to split the liquid or gaseous molecules to separate the Hydrogen ions and the Carbon ions at the interface between the first substance and the liquid-metal electrode, and
the counter-electrode comprises a cation sink for the Carbon ions, wherein the Carbon ions are to transit from the interface between the first substance and the liquid-metal electrode through the liquid-metal electrode and the electrolyte to participate in the second redox half-reaction at the counter-electrode, converting the electrical energy into the chemical bond energy of the electro-chemical redox reaction,
wherein by-products of the electro-chemical redox reaction includes a Carbon by-product formed at the counter-electrode and Hydrogen gas formed at the liquid-metal electrode,
the system further comprising:
a second liquid-metal electrode, wherein a third redox half-reaction is to occur at a second interface between the second liquid-metal electrode and a second substance that comprises the formed Hydrogen gas;
a second electrolyte, wherein the second liquid-metal electrode is in between the second substance and the second electrolyte;
a second counter-electrode comprising Aluminum that is to be electro-chemically oxidized in a fourth redox half-reaction to create Aluminum ions, the third redox half-reaction and the fourth redox half-reaction are a corresponding second pair of redox half-reactions, wherein the Aluminum ions are to transit through the second electrolyte and the second liquid-metal electrode between the second interface and the second counter-electrode in order to combine with the Hydrogen gas at the second interface in the third redox half-reaction of the second pair of redox half-reactions; and
second circuitry electrically coupled to the second liquid-metal electrode and to the second counter-electrode, the second circuitry configured to convert between second electrical energy and second chemical bond energy of a second electro-chemical redox reaction of the second pair of redox half-reactions, wherein the second electro-chemical redox reaction between the Hydrogen ions and the Aluminum are to generate second electrons to power the second circuitry, converting the second chemical bond energy of the second electro-chemical redox reaction into the second electrical energy.

9. The system of claim 2, wherein:
the cations comprise Aluminum ions,
the anions comprise Oxygen ions,
the first substance comprises Air as the source of molecules or atoms for the Oxygen ions, the Air including Oxygen,
the counter-electrode comprises Alane as the cation source substance for the Aluminum ions,
the Aluminum ions are to transit from the counter-electrode through the electrolyte and the liquid-metal electrode to combine with the Oxygen ions at the interface between the first substance and the liquid-metal electrode in the first redox half-reaction, wherein a by-product of the first redox half-reaction includes Alumina, and
the electrolyte is configured to strip the Aluminum ions off the Alane of the counter-electrode, releasing Hydrogen gas.

10. The system of claim 9, further comprising:
a Hydrogen fuel cell configured for using the released Hydrogen gas as a Hydrogen fuel;
a source feed to input into the Hydrogen fuel cell,
wherein the Hydrogen fuel cell is configured for operating, based on the released Hydrogen gas and substance input via the source feed, to generate second electrons to power second circuitry.

11. The system of claim 2, wherein:
the liquid-metal electrode internally contains a mesh configured for creating surface tension, and
a by-product of the chemical redox reaction forms at a liquid-metal surface of the liquid-metal electrode in an additive process as the chemical redox reaction occurs, a shape of the liquid-metal surface based on the surface tension of the mesh, a shape of the by-product based on the shape of the liquid-metal surface of the liquid-metal electrode.

12. The system of claim 11, further comprising:
a nano, mezzo or macro scale template at or near the interface between the first substance and the liquid-metal electrode reaction surface, the template configured for modifying the first redox half-reaction occurring at different locations at the interface, which modifies the by-product forming at the liquid-metal surface of the liquid-metal electrode.

13. The system of claim 2, wherein:
the first substance comprises one or more polar gases as the source of molecules or atoms that are to be electro-chemically reduced to create the anions, and
a by-product of the first redox half-reaction sequesters the one or more polar gases.

14. The system of claim 13 further comprising:
a barrier substance for separating the first substance, which comprises one or more non-polar gases, from an external substance, which comprises the one or more polar gases and one or more non-polar gases;
a second liquid-metal electrode, wherein a third redox half-reaction is to occur at a second interface between the second liquid-metal electrode and a second substance including a first non-polar gas among the one or more non-polar gases, wherein the first non-polar gas is to be electro-chemically reduced to create second anions;
a second electrolyte, wherein the second liquid-metal electrode is in between the second substance and the second electrolyte;
a second counter-electrode comprising a second cation source substance that is to be electro-chemically oxidized in a fourth redox half-reaction to create second cations, the third redox half-reaction and the fourth redox half-reaction are a corresponding second pair of redox half-reactions, wherein the second cations are to transit through the second electrolyte and the second liquid-metal electrode between the second interface and the second counter-electrode in order to combine with the second anions at the second interface in the third redox half-reaction of the second pair of redox half-reactions.

15. A system comprising:
a liquid metal-electrode, wherein a first redox half-reaction is to occur at an interface between a first substance and the liquid-metal electrode;
an electrolyte, wherein the liquid-metal electrode is in between the first substance and the electrolyte;
a counter-electrode in contact with the electrolyte separate from the liquid-metal electrode, wherein a second redox half-reaction is to occur at the counter-electrode, the first redox half-reaction and the second redox half-reaction are a corresponding pair of redox half-reactions, the liquid-metal electrode and the counter-electrode are an electrode pair, anions are to exit one of the pair of redox half-reactions at one of the electrode pair and to transit through the electrolyte and the liquid-metal electrode to participate in the other of the pair of redox half-reactions that is to occur at the other of the electrode pair; and
circuitry electrically coupled to the liquid-metal electrode and to the counter-electrode, the circuitry being configured to convert between electrical energy and chemical bond energy through an electro-chemical redox reaction of the pair of redox half-reactions.

16. The system of claim 15, wherein:
the first substance comprises a source of molecules or atoms that are to be electro-chemically oxidized to create cations,
the counter-electrode comprises a anion source substance that is to be electro-chemically reduced in the second redox half-reaction to create the anions, wherein the anions are to transit from the counter-electrode through the electrolyte and the liquid-metal electrode to combine with the cations at the interface between the first substance and the liquid-metal electrode in the first redox half-reaction, and
the electro-chemical redox reaction of the pair of redox half-reactions between the cations and the anions are to generate electrons to power the circuitry, converting the chemical bond energy of the electro-chemical redox reaction into the electrical energy.

17. The system of claim 15, wherein:
the first substance comprises a source of molecules or atoms that are to be electro-chemically reduced to create the anions,
the circuitry is configured to input the electrical energy to reduce the source of molecules or atoms to create the anions at the interface between the first substance and the liquid-metal electrode, and
the counter-electrode comprises an anion sink for the anions, wherein the anions are to transit from the interface between the first substance and the liquid-metal electrode through the liquid-metal electrode and the electrolyte to the counter-electrode where the second redox half reaction is to occur, converting the electrical energy input into the chemical bond energy of the electro-chemical redox reaction.

18. The system of claim 15, wherein the liquid-metal electrode comprises a substance with a negative standard electrode potential, or wherein a bias voltage is applied to the liquid-metal electrode to maintain the liquid-metal electrode in a negative electrode potential state.

19. The system of claim 15, wherein the liquid-metal electrode comprises a liquid metal or a liquid-metal alloy.

20. The system of claim 16, wherein:
the liquid-metal electrode comprises a mesh configured for creating surface, and
a by-product of the chemical redox reaction forms at a liquid-metal surface of the liquid-metal electrode in an additive process as the chemical redox reaction occurs, a shape of the liquid-metal surface based on the surface tension of the mesh, a shape of the by-product based on the shape of the liquid-metal surface of the liquid-metal electrode.

21. The system of claim 20, further comprising:
a nano, mezzo or macro scale template at or near the interface between the first substance and the liquid-metal electrode reaction surface, the template configured for modifying the first redox half-reaction occurring at different locations at the interface, which modifies the by-product forming at the liquid-metal surface of the liquid-metal electrode.

22. A system comprising:
a fuel cell configured to operate based on a first fuel, the first fuel comprising a first substance; and
a barrier substance located internal in or external to the fuel cell, the barrier substance for separating the first substance, which comprises a non-polar gas, from a second substance, which comprises and the non-polar gas and the one or more polar gases, wherein the barrier permits the first substance to pass through the barrier substance to reach a first operation location where the fuel cell is to use the first substance of the first fuel, wherein the barrier blocks the one or more polar gases mixed with the first substance from reaching the first operation location.
